(19) United States
(12) Patent Application Publication
(10) Pub. No.: US 2026/0008690 A1
(43) Pub. Date: Jan. 8, 2026

(54) METHOD FOR SYNTHESIZING DYSPROSIUM-DOPED COPPER-ZINC FERRITE NANOMATERIALS AND A HUMIDITY SENSING SYSTEM THEREOF

(71) Applicant: PRINCESS NOURAH BINT ABDULRAHMAN UNIVERSITY, Riyadh (SA)

(72) Inventors: Mohd. SHKIR, Abha (SA); Thamraa ALSHAHRANI, Riyadh (SA); Jagadeesha Angadi V, Hubli (IN); Nafis AHMAD, Abha (SA)

(73) Assignee: PRINCESS NOURAH BINT ABDULRAHMAN UNIVERSITY, Riyadh (SA)

(21) Appl. No.: 19/329,530

(22) Filed: Sep. 15, 2025

(51) Int. Cl. C01G 49/00

(52) U.S. Cl. CPC C01G 49/0063; C01P 2002/32; C01P 2002/54; C01P 2002/72; C01P 2002/85; C01P 2004/03; C01P 2006/40

(57) ABSTRACT

The present invention generally relates to a method for synthesizing dysprosium-doped copper-zinc ferrite nanomaterials with enhanced structural and functional properties. The method comprises dissolving stoichiometric quantities of copper nitrate trihydrate, zinc nitrate hexahydrate, iron nitrate nonahydrate, and dysprosium nitrate hexahydrate in distilled water to prepare an oxidizer solution. A fuel mixture is separately prepared using urea and glucose in equal proportions by weight. The oxidizer and fuel mixtures are combined in 1:1 ratio, calculated based on their respective oxidizing and reducing valencies, to form a homogeneous precursor solution. This solution is stirred thoroughly for about one hour and subsequently transferred to a Pyrex dish. The dish is placed in a muffle furnace preheated to approximately 450° C., where the solution undergoes a self-sustained combustion reaction, yielding a fine, porous Cu_{0.5}Zn_{0.5}DyₓFe₂₋ₓO₄ ferrite powder within 20 minutes. The resultant powder is ground to achieve uniform particle distribution suitable for advanced applications.

### FIELD OF THE INVENTION

The present disclosure generally relates to the synthesis of advanced nanomaterials and their application in sensing technologies. More specifically, the present invention pertains to a method for synthesizing dysprosium-doped copper-zinc ferrite nanomaterials and the utilization of these synthesized nanomaterials in the development of highly efficient humidity sensing systems.

### BACKGROUND OF THE INVENTION

The development of advanced materials with tailored properties is crucial for various technological applications, particularly in the fields of electronics, telecommunications, microwave devices, and sensing systems. Rare earth (RE) doped copper-zinc (Cu—Zn) ferrites have garnered significant attention due to their exceptional structural, electrical, and magnetic properties. The strategic substitution of RE ions into the Cu—Zn ferrite matrix effectively modifies their crystal structure, enhances electrical conductivity, and improves critical magnetic characteristics, including saturation magnetization and coercivity.

The incorporation of RE ions into the spinel lattice of Cu—Zn ferrites induces variations in lattice parameters, microstructure, and porosity, all of which profoundly influence their functional attributes. Studies have demonstrated that doping with RE elements such as Gadolinium (Gd), Lanthanum (La), and Dysprosium (Dy) can significantly enhance the electrical resistivity and magnetic permeability of Cu—Zn ferrites, rendering them highly suitable for high-frequency applications. This observed improvement in structural stability is primarily attributed to the robust bonding formed between RE ions and oxygen, which consequently alters the cation distribution within the spinel lattice. Furthermore, the magnetic properties, including coercivity and saturation magnetization, are highly dependent on both the type and concentration of the RE dopant. For instance, Dy-doped Cu—Zn ferrites exhibit an increase in coercivity due to enhanced anisotropy, while La doping has been shown to improve magnetization while maintaining low coercivity. Additionally, RE substitution influences the dielectric constant, making these ferrites valuable for magneto-dielectric applications in antennas and sensors.

Recent advancements in synthesis techniques, such as sol-gel auto-combustion and microwave-assisted combustion, have further optimized the structural and magnetic properties of RE-doped Cu—Zn ferrites. These sophisticated methods enable precise control over particle size and morphology, leading to enhanced performance in applications like electromagnetic shielding and microwave absorption. The continued development of these materials holds immense promise for next-generation electronic and communication devices, as evidenced by numerous studies on their improved functional properties.

Beyond their magnetic and electronic applications, Cu—Zn ferrites are extensively studied for their utility in humidity sensors. Their ability to exhibit changes in electrical resistance in response to varying humidity levels makes them ideal candidates for such applications. Key microstructural properties, including grain size, porosity, and the presence of oxygen vacancies, play a crucial role in determining their sensing efficiency. Copper-zinc spinel ferrite, in particular, demonstrates excellent humidity sensing capabilities owing to its semiconducting nature and high resistivity. Investigations further highlight that the sintering temperature significantly influences the microstructure, electrical, and magnetic characteristics of Cu—Zn ferrites, thereby impacting their humidity sensing efficiency. The synthesis of transition metal-doped ferrites has also been explored to optimize their porosity, a critical parameter for effective humidity sensing.

The incorporation of rare earth elements into Cu—Zn ferrites has been shown to alter their structural and electrical properties, leading to enhanced humidity sensing performance. For example, the substitution of lanthanum (La) in Ni—Zn—Cu—Co ferrites significantly improves their ammonia (NH₃) sensing capabilities, which are closely related to humidity sensing properties. Similarly, Lutetium (Lu)-doped zinc ferrite ceramics have demonstrated an enhanced sensing response and faster recovery time, underscoring the role of rare earth ions in improving sensor stability and repeatability. The doping of other transition metals (Co, Cu, and Ni) in ferrites has also shown promising results in enhancing the sensitivity of humidity sensors.

Comparative studies suggest that Mg—Zn ferrites may exhibit superior humidity sensing properties compared to Cu—Zn ferrites due to their lower eddy current loss and higher stability. However, the strategic introduction of rare earth dopants into Cu—Zn ferrites bridges this performance gap by improving their structural integrity and enhancing their dielectric properties, thus making them competitive candidates for sensor applications. Recent advancements in the synthesis of Cu—Zn ferrites using techniques like sol-gel and auto-combustion have enabled better control over their humidity sensing properties. Natural fuel-assisted synthesis methods have also been explored to develop Mg—Cu ferrites with optimized dielectric and magnetic characteristics for humidity sensors. Future research directions emphasize the development of nanostructured Cu—Zn ferrites with rare earth doping to further enhance their sensitivity and durability. Additionally, combining these materials with polymer composites could offer flexible and low-cost humidity sensors for various industrial applications. Overall, the incorporation of rare-earth elements into Cu—Zn ferrites results in enhanced sensitivity, faster response times, and greater stability in humidity sensors, opening new opportunities for the development of reliable and high-performance humidity sensors for industrial and environmental applications.

Humidity sensors are indispensable components in a wide array of applications, including environmental monitoring, industrial process control, agriculture, and consumer electronics. Traditional sensing materials, such as polymer composites, various metal oxides (e.g., SnO₂, ZnO), and carbon-based systems, exhibit varying levels of sensitivity, response time, and long-term stability. However, these conventional materials frequently suffer from inherent limitations, including slow response and recovery behavior, instability under prolonged operational conditions, and significant hysteresis during the adsorption-desorption cycle.

Ferrite-based materials, particularly spinel ferrites like NiFe₂O₄, ZnFe₂O₄, and CuFe₂O₄, have emerged as promising candidates for humidity sensing due to their semiconducting nature, high resistivity, and tunable electrical and magnetic properties. Among these, Cu—Zn ferrites exhibit particularly favorable microstructural features, such as high porosity and large grain boundaries, which are conducive to efficient water molecule adsorption and improved sensing sensitivity.

Recent advancements in the field have explored the strategic doping of spinel ferrites with rare-earth ions (e.g., Gd³⁺, La³⁺, Dy³⁺) to modulate their structural, electrical, and sensing properties. Rare-earth ions, owing to their relatively large ionic radii and strong interactions with oxygen, possess the capability to significantly alter lattice strain, cation distribution, and surface adsorption characteristics. While some prior works have demonstrated that rare-earth substitution can indeed improve sensitivity and reduce hysteresis, a critical limitation remains: the response and recovery times typically exceed 20 seconds, which is often too slow for many practical applications. Furthermore, the long-term durability of these materials under varying operational conditions has not been comprehensively addressed in prior art.

Despite these ongoing developments, there remains a persistent and unmet need for a cost-effective, ferrite-based humidity sensing material that can simultaneously exhibit rapid response and recovery behavior, enhanced sensitivity, minimal hysteresis, and robust long-term operational stability, especially when subjected to fluctuating humidity conditions.

The present invention directly addresses these aforementioned limitations by providing Dysprosium-doped Cu—Zn ferrite nanomaterials. These nanomaterials are synthesized via a solution combustion route, an approach that yields a highly porous, nanostructured material characterized by a large surface area and optimized electrical and magnetic behavior. This innovative approach ultimately results in exceptional humidity sensing performance, overcoming the shortcomings of existing technologies.

### SUMMARY OF THE INVENTION

The present disclosure seeks to provide humidity sensing material composed of Dysprosium-doped Cu—Zn ferrite nanoparticles with the general formula Cu_{0.5}Zn_{0.5}DyₓFe₂₋ₓO₄ (where 0≤x≤0.02), synthesized via a solution combustion method using a urea-glucose fuel mixture. The invention provides a humidity sensor that exhibits rapid response and recovery times, high sensitivity, minimal hysteresis, and excellent long-term stability, making it suitable for industrial and environmental monitoring applications. The material features a porous nanostructure with uniform grain distribution and high surface area, enabling enhanced adsorption of water molecules. The controlled doping of Dysprosium (Dy³⁺) into the spinel ferrite lattice results in modifications to the crystal structure, particle size, and electronic properties, thereby improving the sensing characteristics. In one embodiment, the sensor composed of Cu_{0.5}Zn_{0.5}Dy_{0.02}Fe_{1.98}O₄ exhibits a maximum humidity sensing response of approximately 96.99%, a response time of 10 seconds, and a recovery time of 12 seconds in the relative humidity range of 11% to 97%. The material demonstrates negligible hysteresis and maintains stable performance over a period of at least two months. The invention further includes a synthesis method involving a cost-effective, energy-efficient combustion route, which enables the scalable production of nanostructured ferrites with desired properties. Thus, the present invention offers an advanced humidity sensing material with superior performance, process simplicity, and durability, providing significant improvements over existing ferrite-based and conventional humidity sensors.

In an embodiment, a dysprosium-doped copper-zinc ferrite nanomaterials composition is disclosed. The composition includes comprising: 40-60 wt. % of oxidizer solution consisting of: 10-15 wt. % of copper nitrate trihydrate (Cu(NO₃)₂·3H₂O); 10-15 wt. % of zinc nitrate hexahydrate (Zn(NO₃)₂·6H₂O); 59-38 wt. % of iron nitrate nonahydrate (Fe(NO₃)₃·9H₂O); 1-2 wt. % of dysprosium nitrate hexahydrate (Dy(NO₃)₃·6H₂O); and 20-30 wt. % of distilled water; and 60-40 wt. % of fuel mixture consisting of: 40-60 wt. % of urea (NH₂CONH₂); and 60-40 wt. % of glucose (C₆H₁₂O₆).

In another embodiment, the weight ratio of oxidizer solution to fuel mixture is 1:1; wherein the weight percentage of copper nitrate trihydrate (Cu(NO₃)₂·3H₂O), zinc nitrate hexahydrate (Zn(NO₃)₂·6H₂O), iron nitrate nonahydrate (Fe(NO₃)₃·9H₂O), dysprosium nitrate hexahydrate (Dy(NO₃)₃·6H₂O), and distilled water is 13.11%, 13.49%, 45.64%, 1.34%, and 26.41%, respectively; and wherein the weight percentage of urea (NH₂CONH₂), and glucose (C₆H₁₂O₆), is 50%, and 50%, respectively.

In a further embodiment, a method for synthesizing dysprosium-doped copper-zinc ferrite nanomaterials is disclosed. The method includes dissolving 10-15 wt. % of copper nitrate trihydrate (Cu(NO₃)₂·3H₂O), 10-15 wt. % of zinc nitrate hexahydrate (Zn(NO₃)₂·6H₂O), 59-38 wt. % of iron nitrate nonahydrate (Fe(NO₃)₃·9H₂O), and 1-2 wt. % of dysprosium nitrate hexahydrate (Dy(NO₃)₃·6H₂O) in 20-30 wt. % of distilled water to form an oxidizer solution. The method further includes preparing a fuel mixture comprising 40-60 wt. % of urea (NH₂CONH₂) and 60-40 wt. % of glucose (C₆H₁₂O₆) in a 50:50 ratio. The method further includes mixing 40-60 wt. % of oxidizer solution with 60-40 wt. % of fuel mixture, preferably in 1:1 ratio, considering their oxidizing and reducing valencies, to form a homogeneous solution. The method further includes stirring the homogeneous solution for approximately one hour. The method further includes transferring the stirred solution into a Pyrex dish and placing the Pyrex dish containing the solution into a preheated muffle furnace at approximately 450° C. The method further includes allowing the solution to undergo a vigorous combustion reaction, characterized by initial boiling followed by ignition, to produce a fine, porous Cu_{0.5}Zn_{0.5}DyₓFe₂₋ₓO₄ ferrite powder within approximately 20 minutes. The method further includes grinding the obtained ferrite powder into fine particles to ensure homogeneity.

In a further embodiment, a humidity sensing system is disclosed. The system comprising: at least one sensing element composed of Dy-doped Cu—Zn ferrite nanomaterial of formula Cu_{0.5}Zn_{0.5}DyₓFe₂₋ₓO₄ synthesized by the above method. The system further includes a substrate on which the sensing material is deposited. The system further includes a controller configured to detect resistance or capacitance variations in the sensing element due to ambient humidity changes. The system further includes a signal processing unit operatively connected to the sensing element and configured to convert the detected signal into a corresponding humidity reading. The system further includes a display or communication interface to convey the measured humidity data to a user or external device.

An object of the present disclosure is to provide a novel humidity sensing material comprising Dysprosium-doped Cu—Zn ferrite nanoparticles with the general formula Cu_{0.5}Zn_{0.5}DyₓFe₂₋ₓO₄ (where 0≤x≤0.02). This material is designed to exhibit superior humidity sensing characteristics.

Another object of the present disclosure is to provide a synthesis method for these Dysprosium-doped Cu—Zn ferrite nanomaterials. This method, specifically a solution combustion method using a urea-glucose fuel mixture, aims to be cost-effective, energy-efficient, and scalable for producing nanostructured ferrites with desired properties.

Additionally, an object of the invention is to achieve a humidity sensing material with a porous nanostructure, uniform grain distribution, and high surface area, thereby enhancing the adsorption of water molecules and improving sensing performance.

Finally, an object of the present invention is to provide a humidity sensing system that integrates these advanced Dysprosium-doped Cu—Zn ferrite nanomaterials, offering significant improvements in performance, process simplicity, and durability compared to existing humidity sensors.

Yet another object of the present invention is to deliver an expeditious and cost-effective humidity sensor utilizing these Dysprosium-doped Cu—Zn ferrite nanoparticles that demonstrates rapid response and recovery times, high sensitivity, minimal hysteresis, and excellent long-term stability for various monitoring applications.

To further clarify the advantages and features of the present disclosure, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail in the accompanying drawings.

### BRIEF DESCRIPTION OF FIGURES

These and other features, aspects, and advantages of the present disclosure will become better understood when the following detailed description is read concerning the accompanying drawings in which like characters represent like parts throughout the drawings, wherein:

FIG. 1(a) illustrates XRD patterns of Cu_{0.9}Zn_{0.1}DyₓFe₂₋ₓO₄ with x=0, 0.005, 0.01, 0.015, and 0.02.

FIG. 1(b) illustrates Rietveld refinement of Cu_{0.9}Zn_{0.1}DyₓFe₂O₄ (x=0).

FIG. 1(c) illustrates Rietveld refinement of Cu_{0.9}Zn_{0.1}Dy_{0.005}Fe_{1.99504} (x=0.005).

FIG. 1(d) illustrates Rietveld refinement of Cu_{0.9}Zn_{0.1}Dy_{0.01}Fe_{1.9904} (x=0.01).

FIG. 1(e) illustrates Rietveld refinement of Cu_{0.9}Zn_{0.1}Dy_{0.015}Fe_{1.985}O₄ (x=0.015).

FIG. 1(f) illustrates Rietveld refinement of Cu_{0.9}Zn_{0.1}Dy_{0.02}Fe_{1.98}O₄ (x=0.02).

FIG. 2(a) illustrates SEM micrograph of Cu_{0.5}Zn_{0.5}Fe₂O₄ (x=0) at 1 μm scale.

FIG. 2(b) illustrates SEM micrograph of Cu_{0.5}Zn_{0.5}Dy_{0.005}Fe_{1.99504} (x=0.005) at 1 μm scale.

FIG. 2(c) illustrates SEM micrograph of Cu_{0.5}Zn_{0.5}Dy_{0.01}Fe_{1.9904} (x=0.01) at 1 μm scale.

FIG. 2(d) illustrates SEM micrograph of Cu_{0.5}Zn_{0.5}Dy_{0.015}Fe_{1.985}O₄ (x=0.015) at 1 μm scale.

FIG. 2(e) illustrates SEM micrograph of Cu_{0.5}Zn_{0.5}Dy_{0.02}Fe_{1.98}O₄ (x=0.02) at 1 μm scale.

FIG. 3(a) illustrates EDAX spectrum of Cu_{0.5}Zn_{0.5}Fe₂O₄ (x=0).

FIG. 3(b) illustrates EDAX spectrum of Cu_{0.5}Zn_{0.5}Dy_{0.005}Fe_{1.99504} (x=0.005).

FIG. 3(c) illustrates EDAX spectrum of Cu_{0.5}Zn_{0.5}Dy_{0.01}Fe_{1.9904} (x=0.01).

FIG. 3(d) illustrates EDAX spectrum of Cu_{0.5}Zn_{0.5}Dy_{0.015}Fe_{1.985}O₄ (x=0.015).

FIG. 3(e) illustrates EDAX spectrum of Cu_{0.5}Zn_{0.5}Dy_{0.02}Fe_{1.98}O₄ (x=0.02).

FIG. 4(a) illustrates M-H loop of Cu_{0.5}Zn_{0.5}Fe₂O₄ (x=0).

FIG. 4(a′) illustrates Enlarged M-H loop near origin for Cu_{0.5}Zn_{0.5}Fe₂O₄ (x=0).

FIG. 4(a″) illustrates FORC diagram of Cu_{0.5}Zn_{0.5}Fe₂O₄ (x=0).

FIG. 4(b) illustrates M-H loop of Cu_{0.5}Zn_{0.5}Dy_{0.005}Fe_{1.99504} (x=0.005).

FIG. 4(b′) illustrates Enlarged M-H loop near origin for Cu_{0.5}Zn_{0.5}Dy_{0.005}Fe_{1.99504} (x=0.005).

FIG. 4(b″) illustrates FORC diagram of Cu_{0.5}Zn_{0.5}Dy_{0.005}Fe_{1.99504} (x=0.005).

FIG. 4(c) illustrates M-H loop of Cu_{0.5}Zn_{0.5}Dy_{0.01}Fe_{1.9904} (x=0.01).

FIG. 4(c′) illustrates Enlarged M-H loop near origin for Cu_{0.5}Zn_{0.5}Dy_{0.01}Fe_{1.9904} (x=0.01).

FIG. 4(c″) illustrates FORC diagram of Cu_{0.5}Zn_{0.5}Dy_{0.01}Fe_{1.9904} (x=0.01).

FIG. 4(d) illustrates M-H loop of Cu_{0.5}Zn_{0.5}Dy_{0.015}Fe_{1.985}O₄ (x=0.015).

FIG. 4(d′) illustrates Enlarged M-H loop near origin for Cu_{0.5}Zn_{0.5}Dy_{0.015}Fe_{1.985}O₄ (x=0.015).

FIG. 4(d″) illustrates FORC diagram of Cu_{0.5}Zn_{0.5}Dy_{0.015}Fe_{1.985}O₄ (x=0.015).

FIG. 4(e) illustrates M-H loop of Cu_{0.5}Zn_{0.5}Dy_{0.02}Fe_{1.98}O₄ (x=0.02).

FIG. 4(e′) illustrates Enlarged M-H loop near origin for Cu_{0.5}Zn_{0.5}Dy_{0.02}Fe_{1.98}O₄ (x=0.02).

FIG. 4(e″) illustrates FORC diagram of Cu_{0.5}Zn_{0.5}Dy_{0.02}Fe_{1.98}O₄ (x=0.02).

FIG. 5 illustrates Resistance variation of Cu_{0.5}Zn_{0.5}DyₓFe₂₋ₓO₄ samples as a function of relative humidity (% RH) showing improved humidity sensing performance with increased Dy content.

FIG. 6 illustrates Sensing response versus relative humidity for various Dy doping concentrations, highlighting highest sensitivity in the x=0.02 sample.

FIG. 7 illustrates Response and recovery time curves of the ZCDF5 (x=0.02) sample, demonstrating rapid sensor performance under humidity switching.

FIG. 8 illustrates Humidity hysteresis curve for ZCDF5, showing minimal difference between adsorption and desorption cycles, indicating good reversibility.

FIG. 9 illustrates Long-term humidity sensing stability test results of ZCDF5 over 60 days at 55% and 97% RH, demonstrating excellent durability.

FIG. 10(a) illustrates Optical absorption spectra of Cu_{0.5}Zn_{0.5}DyₓFe₂₋ₓO₄ (x=0, 0.005, 0.01, 0.015, 0.02).

FIG. 10(b) illustrates Bandgap estimation of Cu_{0.5}Zn_{0.5}Fe₂O₄ (x=0) with Eg=2.27 eV.

FIG. 10(c) illustrates Bandgap estimation of Cu_{0.5}Zn_{0.5}Dy_{0.005}Fe_{1.99504} (x=0.005) with Eg=2.30 eV.

FIG. 10(d) illustrates Bandgap estimation of Cu_{0.5}Zn_{0.5}Dy_{0.01}Fe_{1.9904} (x=0.01) with Eg=2.41 eV.

FIG. 10(e) illustrates Bandgap estimation of Cu_{0.5}Zn_{0.5}Dy_{0.015}Fe_{1.985}O₄ (x=0.015) with Eg=2.47 eV.

FIG. 10(f) illustrates Bandgap estimation of Cu_{0.5}Zn_{0.5}Dy_{0.02}Fe_{1.98}O₄ (x=0.02) with Eg=2.36 eV.

FIG. 11 illustrates a block diagram of a humidity sensing system in accordance with an embodiment of the present disclosure.

FIG. 12 illustrates a flow chart of a method for synthesizing dysprosium-doped copper-zinc ferrite nanomaterials in accordance with an embodiment of the present disclosure.

FIG. 13 illustrates a Table depicting Structural Parameter obtained by XRD data.

FIG. 14 illustrates a Table depicting Magnetization Parameters of Cu_{0.5}Zn_{0.5}DyₓFe₍₂₋ₓ₎O₄ (where x=0, 0.005, 0.01, 0.015, and 0.02).

Further, skilled artisans will appreciate those elements in the drawings are illustrated for simplicity and may not have necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION

To promote an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail concerning the accompanying drawings.

In an embodiment, a dysprosium-doped copper-zinc ferrite nanomaterials composition is disclosed. The composition includes comprising: 40-60 wt. % of oxidizer solution consisting of: 10-15 wt. % of copper nitrate trihydrate (Cu(NO₃)₂·3H₂O); 10-15 wt. % of zinc nitrate hexahydrate (Zn(NO₃)₂·6H₂O); 59-38 wt. % of iron nitrate nonahydrate (Fe(NO₃)₃·9H₂O); 1-2 wt. % of dysprosium nitrate hexahydrate (Dy(NO₃)₃·6H₂O); and 20-30 wt. % of distilled water; and 60-40 wt. % of fuel mixture consisting of: 40-60 wt. % of urea (NH₂CONH₂); and 60-40 wt. % of glucose (C₆H₁₂O₆).

In another embodiment, the weight ratio of oxidizer solution to fuel mixture is 1:1; wherein the weight percentage of copper nitrate trihydrate (Cu(NO₃)₂·3H₂O), zinc nitrate hexahydrate (Zn(NO₃)₂·6H₂O), iron nitrate nonahydrate (Fe(NO₃)₃·9H₂O), dysprosium nitrate hexahydrate (Dy(NO₃)₃·6H₂O), and distilled water is 13.11%, 13.49%, 45.64%, 1.34%, and 26.41%, respectively; and wherein the weight percentage of urea (NH₂CONH₂), and glucose (C₆H₁₂O₆), is 50%, and 50%, respectively.

### Synthesis Method

The Cu_{0.5}Zn_{0.5}DyₓFe₍₂₋ₓ₎O₄ ferrite samples (where x=0, 0.005, 0.01, 0.015, and 0.02) were synthesized using the solution combustion method. In this process, stoichiometric amounts of Cu(NO₃)₂·3H₂O, Zn(NO₃)₂·6H₂O, Fe(NO₃)₃·9H₂O, and Dy(NO₃)₃·6H₂O were dissolved in distilled water. These metal nitrates serve as oxidizers, and the corresponding amount was calculated based on the desired stoichiometry of the Cu_{0.5}Zn_{0.5}DyₓFe₍₂₋ₓ₎O₄ composition. For the fuel, a mixture of urea [NH₂CONH₂] and glucose [C₆H₁₂O₆] in a 50:50 ratio were used, ensuring an exothermic reaction during combustion. The fuel and oxidizers were mixed in equimolar proportions, taking into account their oxidizing and reducing valencies. The solution was continuously stirred using a magnetic stirrer for one hour to achieve a homogeneous mixture. After stirring, the solution was transferred into a Pyrex dish and placed in a preheated muffle furnace at 450° C. The solution initially boiled, then ignited, and underwent a vigorous combustion reaction, producing fine, porous ferrite powder within 20 minutes. Once the combustion was complete, the obtained powder was ground into fine particles to ensure homogeneity. This method provides a rapid and energy-efficient synthesis route, yielding fine, homogeneous ferrite powders with a high degree of structural purity.

The prepared Cu_{0.5}Zn_{0.5}DyₓFe₍₂₋ₓ₎O₄ ferrite samples were subjected to further characterization, including X-ray diffraction (XRD) and other techniques, to confirm the structural and magnetic properties of the materials.

### Characterization

All synthesized samples were studied X-ray diffraction (XRD). A typical X-ray diffractometer (Rigaku miniflex-600) equipped with a Cu-Ka radiation source (λ=1.5406 Å) is used, operating at 40 kV and 40 mA. The diffraction data is collected over a 20 range of 10° to 80°, with a step width of 0.002° and scan speed 10° per minute. Crystallite size is calculated using the Scherrer formula via analysis software like High Score Plus. Morphological study were done by using Scanning Electron Microscopy (SEM) and spectra were obtained with ZEISS EVO LS15 operated at 15 kV and surface morphology is observed at magnifications around 10.00KX using a secondary electron detector (SAED). The instrument provides detailed insights into particle size and agglomeration.

### Humidity Sensing Measurement

The experimental details for humidity measurement of Cu_{0.5}Zn_{0.5}DyₓFe₍₂₋ₓ₎O₄ ferrite samples involve precise control of relative humidity (RH) to assess the sensing response and recovery times of the material. Typically, two chambers are maintained: one at low RH (˜11%) and the other at high RH (˜97%). These chambers allow the material to be subjected to controlled humidity environments to observe changes in electrical resistance. The ferrite samples are rapidly moved between these two chambers, with a switching time of 1 second, to record the time taken for the material's resistance to respond to changes in humidity. The response time is measured during the transition from low to high RH, while the recovery time is measured during the transition from high to low RH.

The variation in resistance is a critical measure of the humidity sensing performance of the samples. For higher Dy-doped samples (such as ZCDF5 with x=0.02), the resistance decreases significantly in response to increasing humidity. This is attributed to the increased surface area and improved water adsorption sites, which enhance the interaction with water molecules. The response time, which indicates how quickly the sample detects changes in humidity, improves with higher Dy doping levels. ZCDF5 showed the fastest response time (approximately 10 seconds), making it a highly sensitive material for humidity sensors.

The recovery time, which is the time taken for the sample to return to its original state after the humidity is reduced, also improves with higher Dy content. The improved performance of the Cu_{0.5}Zn_{0.5}DyₓFe₍₂₋ₓ₎O₄ samples is due to the fine-tuned nanostructure that offers more active sites for water interaction.

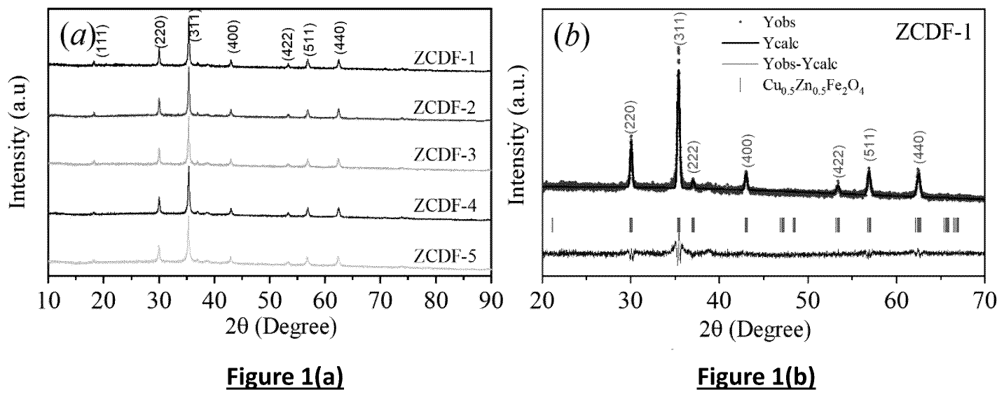

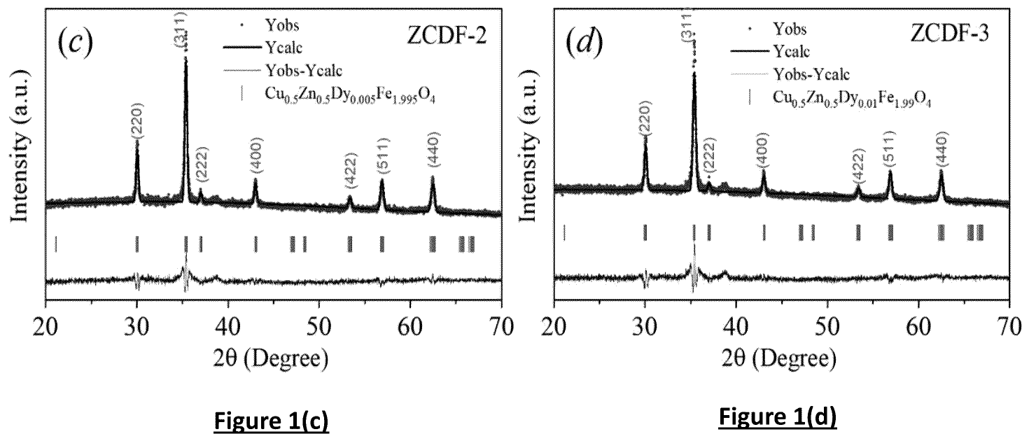

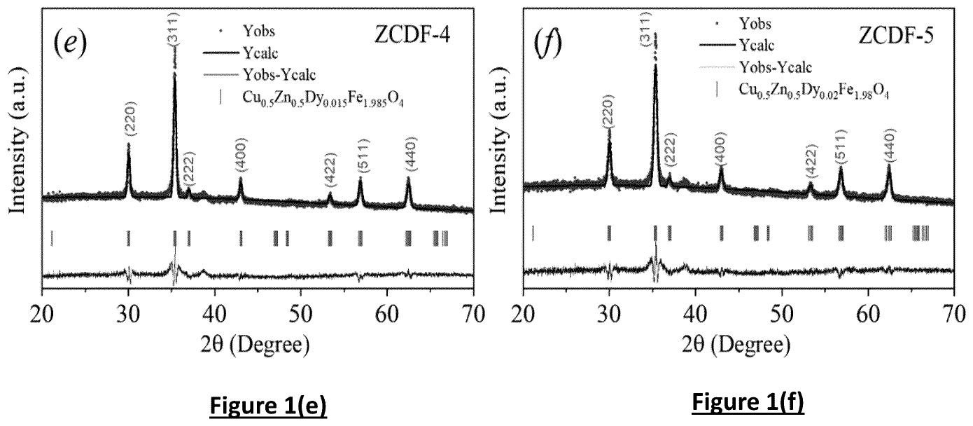

FIG. 1(a): XRD patterns of Cu_{0.9}Zn_{0.1}DyₓFe₂₋ₓO₄ with x=0, 0.005, 0.01, 0.015, and 0.02. FIG. 1(b): Rietveld refinement of Cu_{0.9}Zn_{0.1}Dy₀Fe₂O₄ (x=0). FIG. 1(c): Rietveld refinement of Cu_{0.9}Zn_{0.1}Dy_{0.005}Fe_{1.99504} (x=0.005). FIG. 1(d): Rietveld refinement of Cu_{0.9}Zn_{0.1}Dy_{0.01}Fe_{1.9904} (x=0.01). FIG. 1(c): Rietveld refinement of Cu_{0.9}Zn_{0.1}Dy_{0.015}Fe_{1.985}O₄ (x=0.015). FIG. 1(f): Rietveld refinement of Cu_{0.9}Zn_{0.1}Dy_{0.02}Fe_{1.98}O₄ (x=0.02). Referring to FIGS. 1 (a-f), X-ray diffraction (XRD) patterns of Cu_{0.5}Zn_{0.5}DyₓFe₂₋ₓO₄ samples (x=0, 0.005, 0.01, 0.015, and 0.02), confirming the spinel structure and shift in peak position with Dy doping is illustrated in accordance with an embodiment of the present disclosure.

The X-ray diffraction (XRD) pattern provided for the Cu_{0.5}Zn_{0.5}DyₓFe₍₂₋ₓ₎O₄ (where x=0, 0.005, 0.01, 0.015, and 0.02) ferrite samples shows the prominent diffraction peaks corresponding to the (311) plane, which is a characteristic of the spinel ferrite structure as shown in FIG. 1 (a-f). The consistent appearance of the (311) peak across all samples confirms that the cubic spinel structure of Cu—Zn ferrite is preserved even after doping with dysprosium (Dy). As the Dy content increases from 0 to 0.02, there is a slight shift in the 2θ position of the (311) peak. The peak position for Cu_{0.5}Zn_{0.5}Fe₂O₄ (undoped) is at 35.45346°, while for the sample doped with Dy (x=0.02), the peak shifts to 35.44195°. This shift in peak position indicates a small change in the lattice parameter, which is expected due to the substitution of larger Dy³⁺ ions (ionic radius ˜1.027 Å) for smaller Fe³⁺ ions (ionic radius ˜0.645 Å) in the spinel structure. This substitution causes a slight expansion of the crystal lattice, as observed in the calculated lattice parameters, which range from 8.380554 Å (undoped) to 8.387419 Å (for x=0.005).

The particle size of the ferrite nanoparticles is calculated using the Scherrer formula, and it shows a general trend of decreasing particle size with increasing Dy content. For the undoped sample, the particle size is 28.88 nm, whereas for the Dy-doped sample with x=0.02, the particle size decreases to 25.86 nm. This reduction in particle size could be attributed to the inhibition of grain growth by the dopant atoms, which limits the coalescence of nanoparticles.

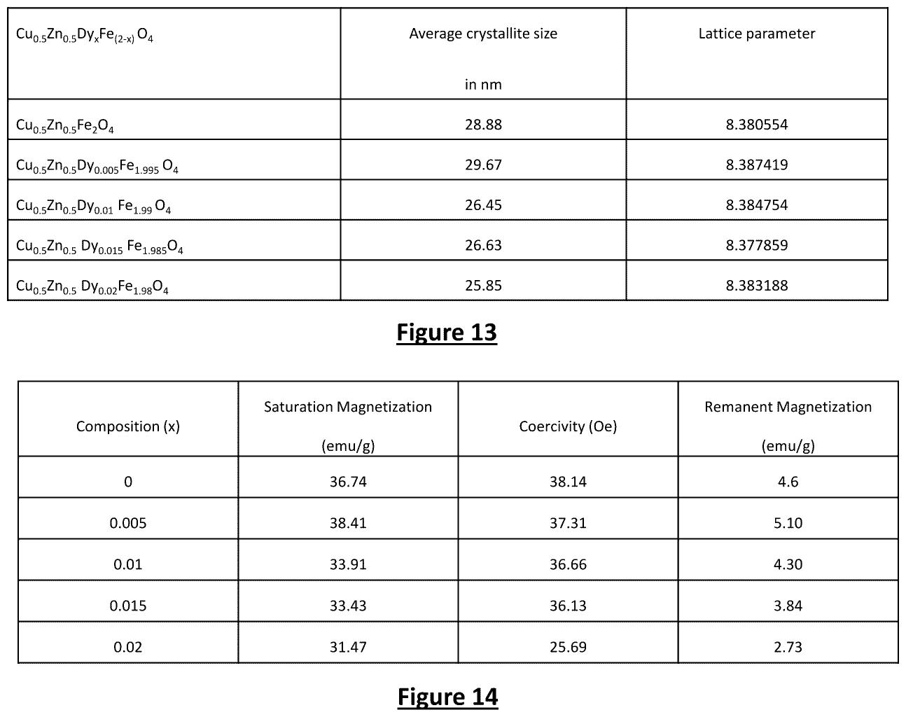

The XRD data confirms the successful substitution of Dy into the Cu—Zn ferrite lattice as shown in Table in FIG. 13, leading to slight modifications in both the lattice parameter and the average crystallite size. The consistency of the spinel structure despite Dy doping indicates good structural stability, making these materials promising for various applications such as sensors and magnetic devices.

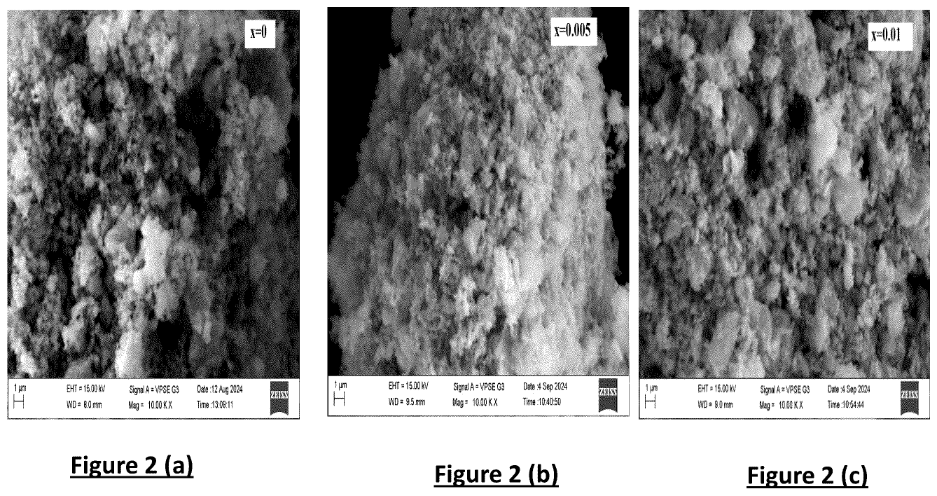

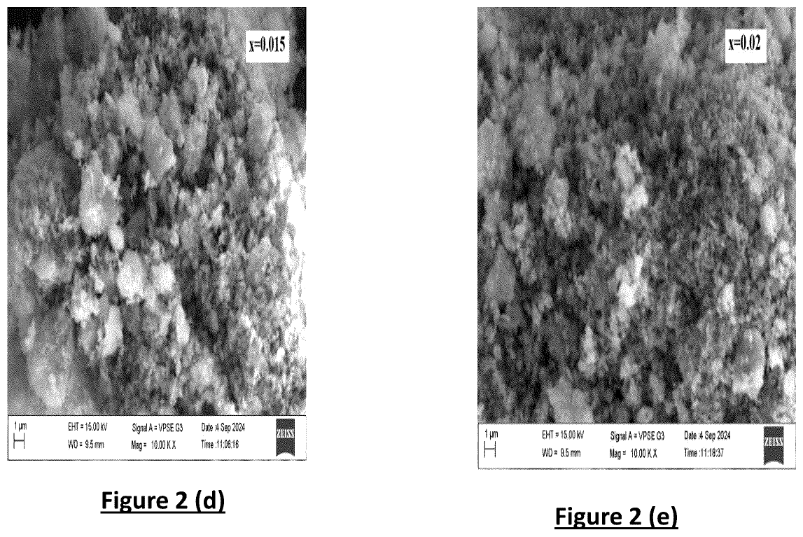

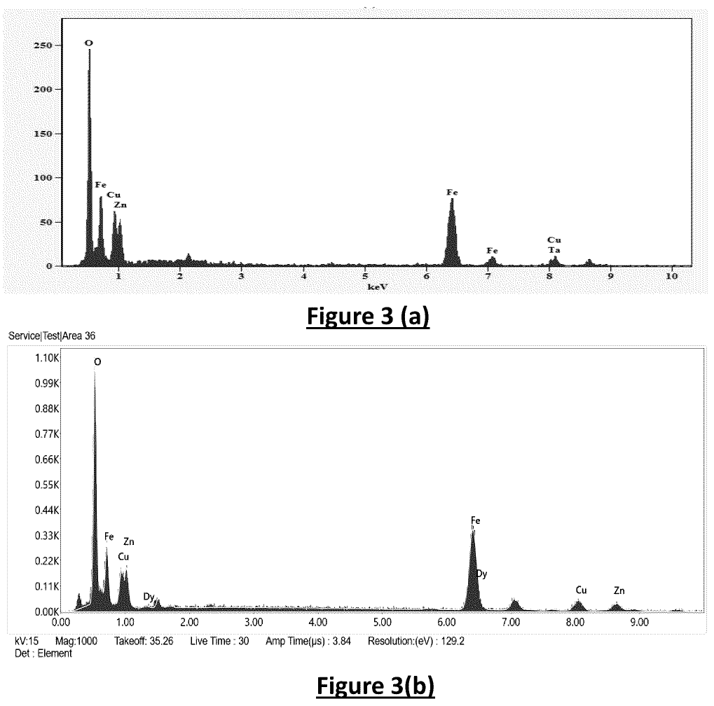

FIG. 2(a): SEM micrograph of Cu_{0.5}Zn_{0.5}Fe₂O₄ (x=0) at 1 μm scale. FIG. 2(b): SEM micrograph of Cu_{0.5}Zn_{0.5}Dy_{0.005}Fe_{1.99504} (x=0.005) at 1 μm scale. FIG. 2(c): SEM micrograph of Cu_{0.5}Zn_{0.5}Dy_{0.01}Fe_{1.9904} (x=0.01) at 1 μm scale. FIG. 2(d): SEM micrograph of Cu_{0.5}Zn_{0.5}Dy_{0.015}Fe_{1.985}O₄ (x=0.015) at 1 μm scale. FIG. 2(c): SEM micrograph of Cu_{0.5}Zn_{0.5}Dy_{0.02}Fe_{1.98}O₄ (x=0.02) at 1 μm scale. FIG. 2(a-e) illustrates Scanning Electron Microscopy (SEM) images showing surface morphology and agglomerated porous structure of Cu_{0.5}Zn_{0.5}DyₓFe₂₋ₓO₄ nanoparticles at various doping levels.

The SEM (Scanning Electron Microscopy) images presented in FIG. 2 (a-c) provide important insights into the morphology of the Cu_{0.5}Zn_{0.5}DyₓFe₍₂₋ₓ₎0₄ samples. The SEM micrographs shows that the particles exhibit an agglomerated structure, consisting of small, densely packed granules. The clusters have a spherical or near-spherical shape, which is typical for ferrite nanoparticles synthesized through common chemical or thermal methods. This kind of morphology is beneficial for applications like humidity sensors, where high surface area is crucial for adsorption processes. Each image showcases particles with varying degrees of porosity. The porous nature of the agglomerates suggests that the material may have a large surface area, which can enhance the sensitivity of the material when used in sensor applications.

The uniform distribution of grains in the clusters indicates that the doping of Dy into the Cu—Zn ferrite matrix does not significantly disturb the particle formation, maintaining structural integrity. The average particle size appears to be in the micrometer range (as denoted by the 3 μm scale bars), but the individual crystallite sizes, likely on the nanoscale, corroborate the XRD analysis, which reported crystallite sizes between 25-30 nm. The combination of nanoparticle-sized crystallites and micrometer-scale agglomerates offers a hierarchical structure, which could be advantageous in achieving both high sensitivity and fast response in sensor technologies. Overall, the morphology seen in these images indicates that the Cu—Zn—Dy ferrite samples are well-suited for applications requiring large surface areas and uniform particle distribution, such as humidity sensing or catalysis.

Energy Dispersive X-ray Analysis (EDAX) was employed to confirm the elemental composition of the synthesized Cu_{0.5}Zn_{0.5}DyₓFe₍₂₋ₓ₎O₄ ferrite samples (where x=0, 0.005, 0.01, 0.015, and 0.02). The spectra obtained for each sample revealed the presence of copper (Cu), zinc (Zn), iron (Fe), dysprosium (Dy), and oxygen (O), which correspond to the elements in the intended stoichiometric ratios. For the undoped Cu_{0.5}Zn_{0.5}Fe₂O₄ sample, the EDAX results confirmed the expected proportions of Cu, Zn, Fe, and O, with no detectable trace of Dy, as anticipated. Upon the introduction of dysprosium in increasing concentrations (x=0.005, 0.01, 0.015, and 0.02), the presence of Dy was clearly detected in all doped samples, confirming its successful incorporation into the ferrite matrix. As the Dy content increased, the relative intensities of the Dy peaks in the EDAX spectra also increased, corresponding to the increased doping levels. The quantification of the EDAX data further confirmed that the actual compositions closely matched the theoretical stoichiometric values, with only minor deviations, likely due to experimental variations during the synthesis process. The oxygen (O) peaks remained consistent across all samples, confirming the stability of the oxide framework despite the introduction of the larger Dy³⁺ ions. No impurities or foreign elements were detected in any of the samples, indicating the high purity of the synthesized ferrites. Overall, EDAX analysis successfully confirmed the elemental composition of the Cu_{0.5}Zn_{0.5}DyₓFe₍₂₋ₓ₎O₄ ferrite samples, verifying the successful doping of Dy and the preservation of the desired stoichiometry in the material.

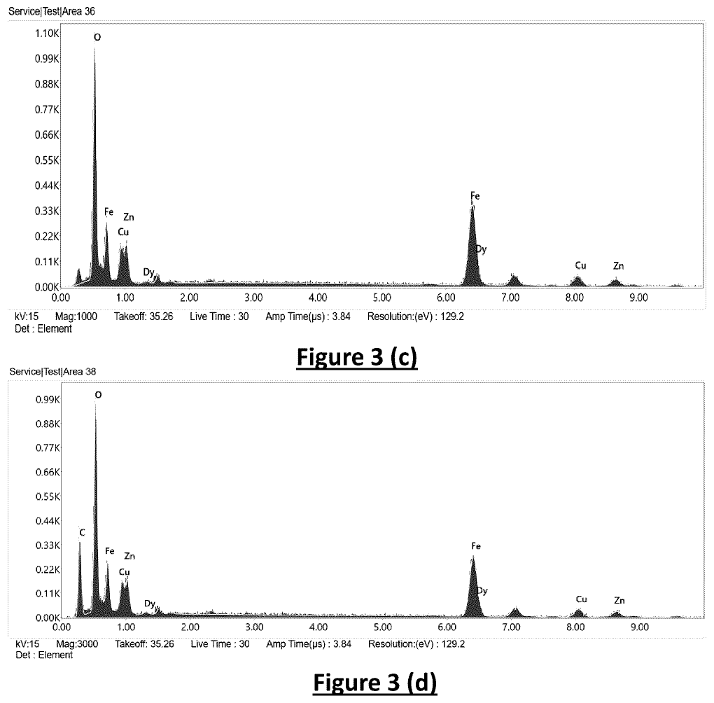

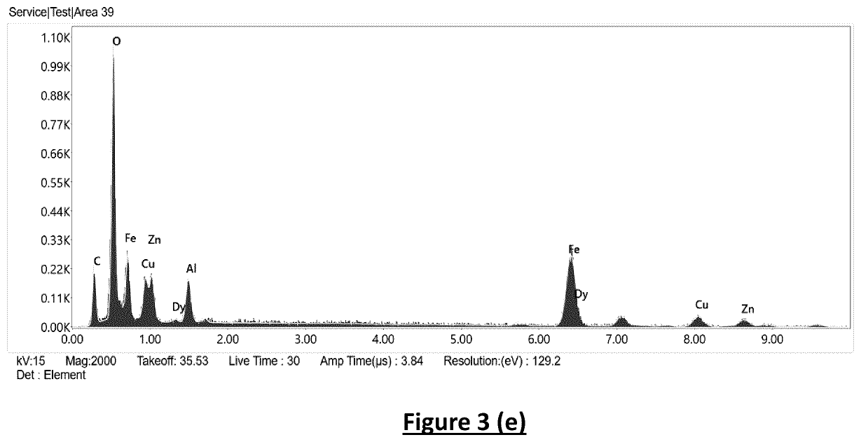

FIG. 3(a-e) illustrates Energy Dispersive X-ray Analysis (EDAX) spectra confirming elemental composition and successful incorporation of Dy in all doped samples. FIG. 3(a): EDAX spectrum of Cu_{0.5}Zn_{0.5}Fe₂O₄ (x=0). FIG. 3(b): EDAX spectrum of Cu_{0.5}Zn_{0.5}Dy_{0.005}Fe_{1.99504} (x=0.005). FIG. 3(c): EDAX spectrum of Cu_{0.5}Zn_{0.5}Dy_{0.01}Fe_{1.99}O₄ (x=0.01). FIG. 3(d): EDAX spectrum of Cu_{0.5}Zn_{0.5}Dy_{0.015}Fe_{1.985}O₄ (x=0.015). FIG. 3(e): EDAX spectrum of Cu_{0.5}Zn_{0.5}Dy_{0.02}Fe_{1.98}O₄ (x=0.02).

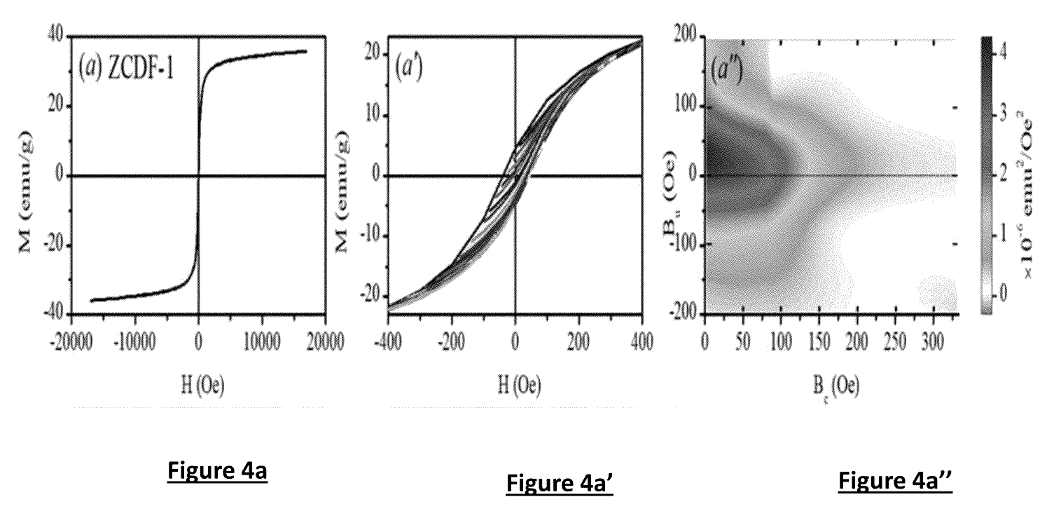

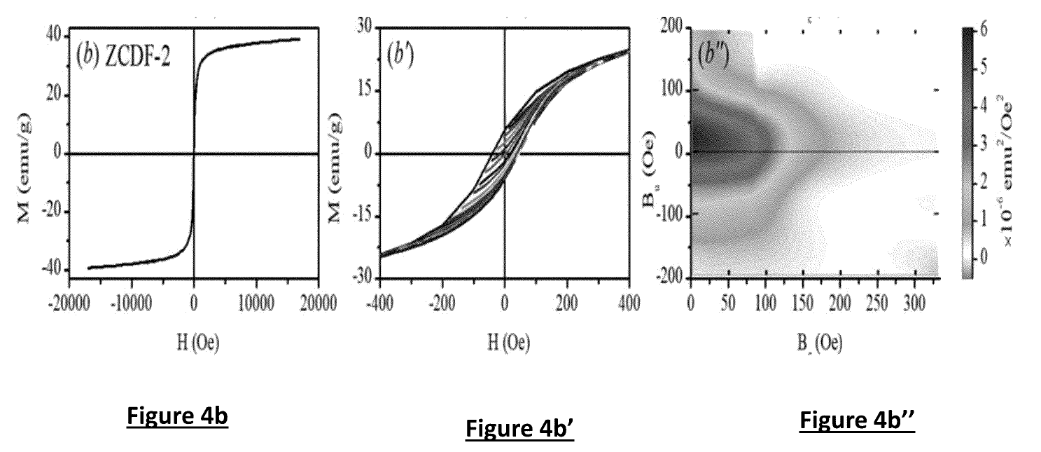

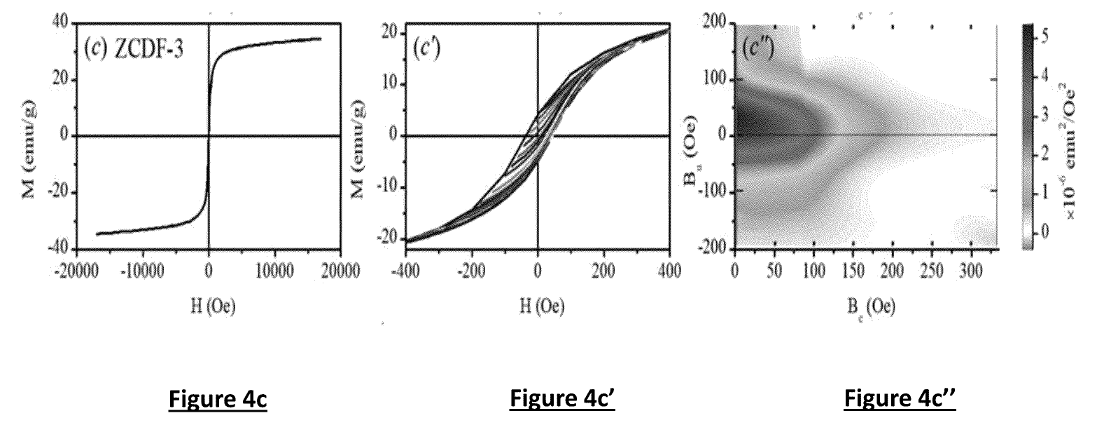

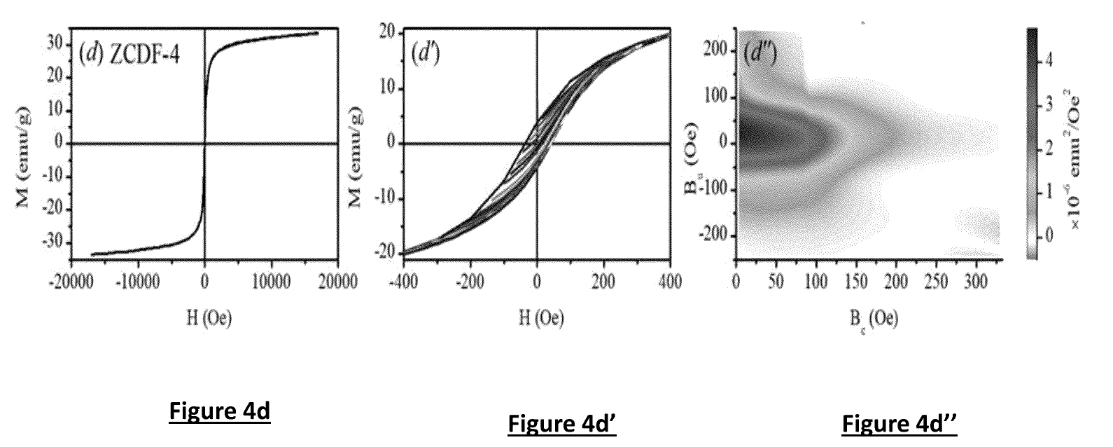

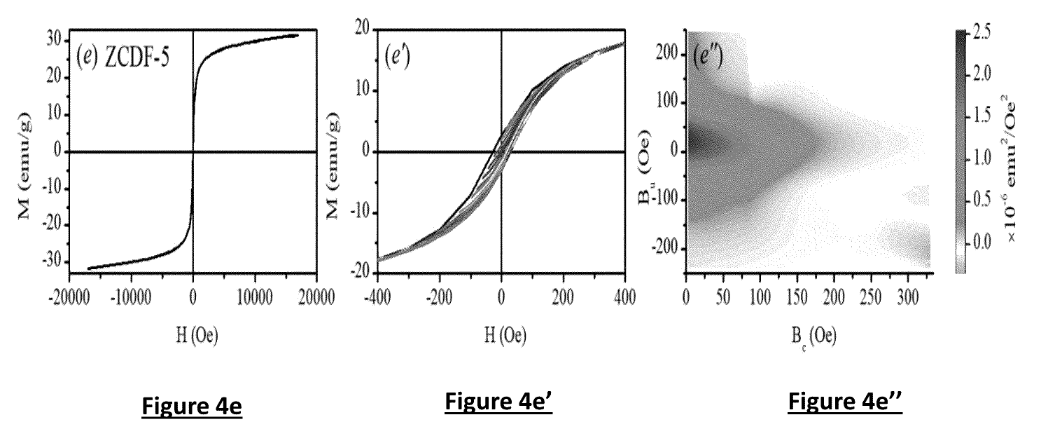

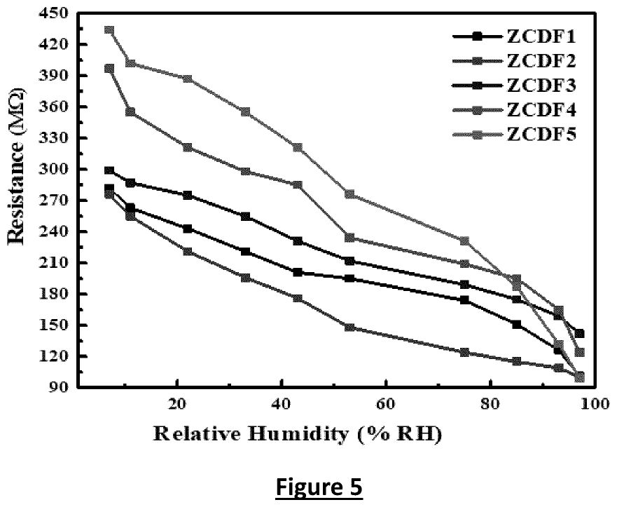

FIG. 4 (a-e) illustrates Room temperature magnetization (M-H) loops and First-Order Reversal Curve (FORC) diagrams of Dy-doped Cu—Zn ferrite samples indicating changes in magnetic properties with doping concentration. FIG. 4(a): M-H loop of Cu_{0.5}Zn_{0.5}Fe₂O₄ (x=0). FIG. 4(a′): Enlarged M-H loop near origin for Cu_{0.5}Zn_{0.5}Fe₂O₄ (x=0). FIG. 4(a″): FORC diagram of Cu_{0.5}Zn_{0.5}Fe₂O₄ (x=0). FIG. 4(b): M-H loop of Cu_{0.5}Zn_{0.5}Dy_{0.005}Fe_{1.995}O₄ (x=0.005). FIG. 4(b′): Enlarged M-H loop near origin for Cu_{0.5}Zn_{0.5}Dy_{0.005}Fe_{1.99504} (x=0.005). FIG. 4(b″): FORC diagram of Cu_{0.5}Zn_{0.5}Dy_{0.005}Fe_{1.99504} (x=0.005). FIG. 4(c): M-H loop of Cu_{0.5}Zn_{0.5}Dy_{0.01}Fe_{1.9904} (x=0.01). FIG. 4(c′): Enlarged M-H loop near origin for Cu_{0.5}Zn_{0.5}Dy_{0.01}Fe_{1.9904} (x=0.01). FIG. 4(c″): FORC diagram of Cu_{0.5}Zn_{0.5}Dy_{0.01}Fe_{1.9904} (x=0.01). FIG. 4(d): M-H loop of Cu_{0.5}Zn_{0.5}Dy_{0.015}Fe_{1.985}O₄ (x=0.015). FIG. 4(d′): Enlarged M-H loop near origin for Cu_{0.5}Zn_{0.5}Dy_{0.015}Fe_{1.985}O₄ (x=0.015). FIG. 4(d″): FORC diagram of Cu_{0.5}Zn_{0.5}Dy_{0.015}Fe_{1.985}O₄ (x=0.015). FIG. 4(c): M-H loop of Cu_{0.5}Zn_{0.5}Dy_{0.02}Fe_{1.98}O₄ (x=0.02). FIG. 4(e′): Enlarged M-H loop near origin for Cu_{0.5}Zn_{0.5}Dy_{0.02}Fe_{1.98}O₄ (x=0.02). FIG. 4(e″): FORC diagram of Cu_{0.5}Zn_{0.5}Dy_{0.02}Fe_{1.98}O₄ (x=0.02).

The room temperature Hysterisis loop were studied Cu_{0.5}Zn_{0.5}DyₓFe₍₂₋ₓ₎O₄ (where x=0, 0.005, 0.01, 0.015, and 0.02) and as shown in FIG. 4. Samples were studied by analyzing the saturation magnetization (Ms), coercivity (Hc), and remanent magnetization (Mr) as functions of dysprosium (Dy) doping. The data, summarized in the Table in FIG. 14, shows distinct trends as Dy concentration increases. For the undoped sample (x=0), the saturation magnetization (Ms) is 36.74 emu/g, showing a relatively strong magnetic response. With the introduction of Dy at x=0.005, Ms increases to 38.41 emu/g, suggesting that the initial Dy doping enhances the ferrite's magnetic moment, likely due to the magnetic coupling between the substituted Dy³⁺ ions and the Fe³⁺ ions in the spinel lattice. However, as the Dy concentration further increases (x=0.01 and higher), Ms shows a declining trend, with values decreasing to 33.91 emu/g at x=0.01, 33.43 emu/g at x=0.015, and 31.47 emu/g at x=0.02. This reduction in Ms with higher Dy content can be attributed to the fact that Dy³⁺ ions have a lower magnetic moment compared to Fe³⁺ ions. Thus, the substitution of Fe³⁺ with Dy³⁺ reduces the overall magnetization due to weaker magnetic interactions in the lattice. Coercivity (Hc), which indicates the material's resistance to demagnetization, shows a high value of 38.14 Oe for the undoped sample, slightly decreasing to 37.31 Oe at x=0.005. This decrease continues with increasing Dy content, with Hc values reaching 36.66 Oe, 36.13 Oe, and finally dropping significantly to 25.69 Oe at x=0.02. The reduction in Hc with higher Dy doping suggests that the presence of Dy softens the magnetic structure, making it easier to demagnetize the material. This is likely due to the disruption of magnetic exchange interactions between Fe³⁺ ions on the A and B sites of the spinel structure. The remanent magnetization (Mr), which measures the residual magnetization after an external magnetic field is removed, follows a similar trend. It starts at 4.6 emu/g for the undoped sample, increases slightly to 5.10 emu/g at x=0.005, and then decreases consistently as Dy content increases, reaching 2.73 emu/g for x=0.02. The reduction in Mr with higher Dy content is consistent with the observed decrease in Ms, indicating that Dy substitution weakens the overall magnetic interactions within the ferrite structure. The incorporation of Dy into Cu_{0.5}Zn_{0.5}Fe₂O₄ initially enhances the magnetic properties at low doping levels, but further increases in Dy concentration result in a gradual reduction in saturation magnetization, coercivity, and remanent magnetization. These results suggest that moderate Dy doping improves the magnetic characteristics, while higher Dy content leads to magnetic softening due to the reduced magnetic moment of Dy³⁺ ions and their influence on the spinel ferrite's magnetic exchange interactions.

### First-Order Reversal Curve (FORC) and FORC Diagram

The first-order reversal curve (FORC) analysis is a powerful tool for characterizing the magnetic behavior of materials, especially in systems with complex magnetic interactions such as Cu_{0.5}Zn_{0.5}DyₓFe₍₂₋ₓ₎O₄ ferrites. FORC measurements provide detailed information about the coercivity distribution and magnetic domain interactions within the material, which are essential for understanding the effects of Dy doping on the ferrites' magnetic properties.

### FORC Curves:

The FORC curves for Cu_{0.5}Zn_{0.5}DyₓFe₍₂₋ₓ₎O₄ (where x=0, 0.005, 0.01, 0.015, and 0.02) show how the magnetization changes as the applied magnetic field is cycled between increasing and decreasing values. These curves provide insight into the reversible and irreversible components of magnetization, offering a deeper understanding of the domain structure and switching fields.

The FORC curves of the undoped sample exhibit narrow hysteresis loops, indicating that the material has a well-defined coercivity with minimal magnetic domain interactions. The sharpness of the loops suggests that the magnetic domains are relatively independent, with low interaction between them. With slight Dy doping (x=0.005), the FORC curves begin to show broader hysteresis loops, implying an increase in domain interactions. This may be due to the introduction of Dy³⁺ ions, which slightly alter the exchange coupling between Fe³⁺ ions, leading to enhanced magnetic anisotropy and interaction among domains. As the Dy concentration increases, the FORC curves broaden further, and the loops become more complex, suggesting increased domain wall pinning and greater interaction between magnetic domains. The presence of larger Dy³⁺ ions in the spinel lattice disrupts the regular magnetic ordering, causing more pronounced irreversible magnetization behavior. This effect becomes more prominent at higher Dy content (x=0.02), where significant domain interaction and pinning are observed, leading to wider and more asymmetric loops.

### FORC Diagrams:

The FORC diagrams, which plot the distribution of coercivities and interaction fields from the FORC data, reveal the magnetic domain interactions in more detail. The FORC diagram for the undoped Cu_{0.5}Zn_{0.5}Fe₂O₄ sample displays a sharp peak near the origin, indicating a narrow distribution of coercive fields and low magnetic interaction between domains. This suggests that the material behaves as a single-domain or weakly interacting multi-domain system. With the introduction of Dy at x=0.005, the FORC diagram broadens slightly, indicating an increase in the distribution of coercive fields. The diagram begins to show evidence of magnetic interaction, as Dy doping induces changes in the local magnetic environment, affecting domain wall movement and pinning. At intermediate Dy concentrations, the FORC diagrams display a more complex pattern, with broader coercive field distributions and the appearance of multiple peaks. This indicates stronger domain interactions, likely caused by the disruption of the spinel structure as Dy³⁺ ions replace Fe³⁺ ions. The presence of Dy leads to a greater variation in local magnetic environments, contributing to an increased interaction field. In the highest Dy-doped sample (x=0.02), the FORC diagram exhibits a significantly broadened and asymmetric distribution, indicating highly complex domain interactions. The broadening of the coercive field distribution reflects strong magnetic domain wall pinning and a substantial increase in interaction fields. This is consistent with the observed reduction in coercivity (Hc) and saturation magnetization (Ms), as the Dy ions introduce more disorder into the magnetic lattice, leading to complex, multi-domain behavior. The FORC and FORC diagram analyses of Cu_{0.5}Zn_{0.5}DyₓFe₍₂₋ₓ₎O₄ ferrites reveal that Dy doping has a profound effect on the magnetic domain interactions. At low Dy concentrations, there is a slight enhancement of magnetic anisotropy and domain interactions, but as the Dy content increases, the material exhibits stronger domain wall pinning and more complex magnetic behavior. This leads to a broader coercivity distribution and higher interaction fields, reflecting the intricate balance between magnetic ordering and disruption introduced by Dy doping. The FORC analysis confirms that higher Dy doping levels result in more significant magnetic interactions and domain complexity, making these materials suitable for applications where tunable magnetic behavior is required.

### Humidity Sensing Studies

The variation of resistance and sensing response with % RH of Cu_{0.5}Zn_{0.5}DyₓFe₍₂₋ₓ₎O₄ ferrites (where x=0(ZCDF1), 0.005(ZCDF2), 0.01(ZCDF3), 0.015(ZCDF4), and 0.02(ZCDF5)) at ambient temperature is similar to the behavior observed in other humidity-sensitive materials. In the humidity range of 11% to 97% RH, the decrease in resistance with increasing relative humidity is particularly prominent in Dy-doped composites. For the undoped sample (ZCDF1), the change in resistance is relatively small, while the doped composites exhibit a significant linear decrease in resistance by multiple orders of magnitude [19-20].

The Cu_{0.5}Zn_{0.5}DyₓFe₍₂₋ₓ₎O₄ composites show an impressive sensing response, which increases with the doping concentration of Dy. The highest sensing response, around 96.99%, is observed for the ZCDF5 composite with x=0.02, suggesting an optimal level of doping for enhanced sensitivity. The most remarkable result is the linearity of the sensing response, even at low relative humidity (RH), which is not common in many other materials that tend to exhibit non-linear behavior at lower RH levels.

The uniform decrease in resistance at both low and high RH in these composites is primarily attributed to the unique hybrid nanostructure of the material. The ferrite nanoparticles provide a porous structure with a high surface area, while the doping with Dy ions enhances the material's hydrophilic properties. This structure increases the number of active sites available for water adsorption, leading to a higher sensitivity to humidity changes. The interaction of Dy with the ferrite matrix also improves the material's response to adsorbed water molecules, as revealed by SEM and XRD studies.

The sensing mechanism can be explained in three sequential steps: chemisorption, physisorption, and condensation. At low RH, water molecules are chemisorbed onto the surface of the ferrite material, dissociating into OH and H′ ions. The hydrophilic nature of the Dy-doped composites provides abundant sites for OH ions to attach, while the H′ ions become mobile, leading to a decrease in resistance. This process forms the first chemisorbed layer. As the RH increases, hydrogen bonding between water molecules and the adsorbed OH ions forms the first physisorbed layer. With further increase in RH, additional water molecules are adsorbed onto this layer, forming the second physisorbed layer, where water molecules become mobile and further reduce the resistance of the composite.[21]

At very high humidity levels, additional physisorbed layers pile up, behaving like bulk liquid water. This leads to a dramatic decrease in resistance, particularly for highly doped samples like ZCDF5. The high surface area, enhanced water adsorption sites, and the uniform structure of the Cu_{0.5}Zn_{0.5}DyₓFe₍₂₋ₓ₎O₄ composites contribute to their excellent linear sensing behavior across a wide range of relative humidity.

FIG. 5 illustrates Resistance variation of Cu_{0.5}Zn_{0.5}DyₓFe₂₋ₓO₄ samples as a function of relative humidity (% RH) showing improved humidity sensing performance with increased Dy content.

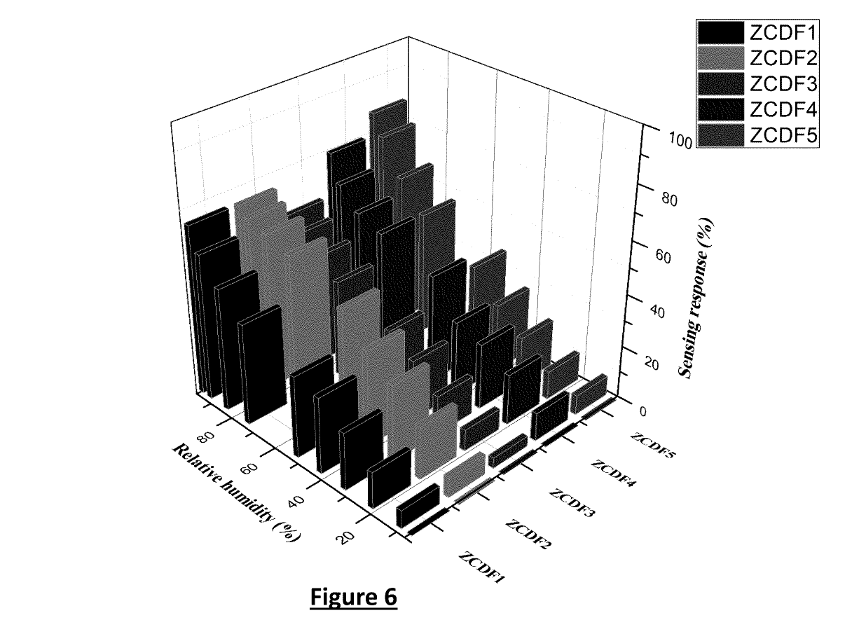

FIG. 6 illustrates Sensing response versus relative humidity for various Dy doping concentrations, highlighting highest sensitivity in the x=0.02 sample.

### Humidity Response and Recovery Behavior

For the fabrication of efficient humidity sensing devices, the critical parameters include response time, recovery time, hysteresis, and long-term stability. In the experimental determination of the response and recovery times for Cu_{0.5}Zn_{0.5}DyₓFe₍₂₋ₓ₎O₄ (where x=0(ZCDF1), 0.005(ZCDF2), 0.01(ZCDF3), 0.015(ZCDF4), and 0.02(ZCDF5)) ferrite composites, two separate chambers were maintained: one with a lower relative humidity (RH) of 20% and another with a higher RH of 100%. The response and recovery times for each sample were measured by switching the samples from 20% RH to 100% RH (response time) and then back from 100% RH to 20% RH (recovery time). The switching interval between RH conditions was set to 1 second for accurate measurements

The response and recovery times for the Cu_{0.5}Zn_{0.5}DyₓFe₍₂₋ₓ₎O₄ composites varied based on the Dy doping levels. While the undoped sample (ZCDF1) exhibited an average response time of 20 seconds and a recovery time of 25 seconds, the Dy-doped composites showed improved performance. The sample with x=0.02 (ZCDF5) demonstrated the fastest response time, recorded at 10 seconds, and a recovery time of 12 seconds. This enhanced performance is attributed to the higher surface area and more active water adsorption sites, which facilitate faster interaction with water molecules.

The Cu_{0.5}Zn_{0.5}DyₓFe₍₂₋ₓ₎O₄ composites with higher Dy doping levels showed a marked improvement in response and recovery times compared to the undoped sample. This improvement is crucial for practical applications where quick and stable sensing behavior is required. Overall, the higher Dy-doped ferrite materials, particularly ZCDF5, exhibited excellent humidity sensing performance, with low hysteresis and high stability, making them suitable for efficient humidity sensing devices.

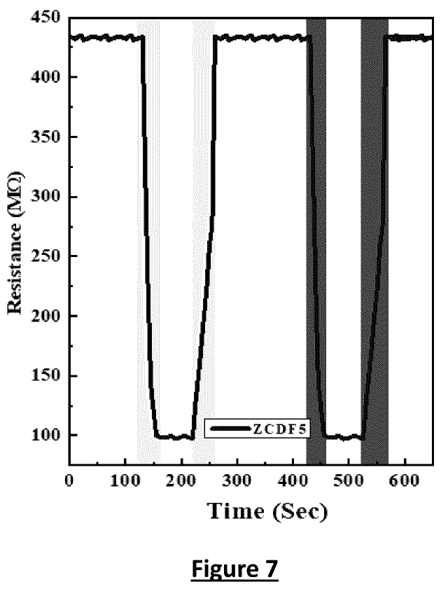

FIG. 7 illustrates Response and recovery time curves of the ZCDF5 (x=0.02) sample, demonstrating rapid sensor performance under humidity switching.

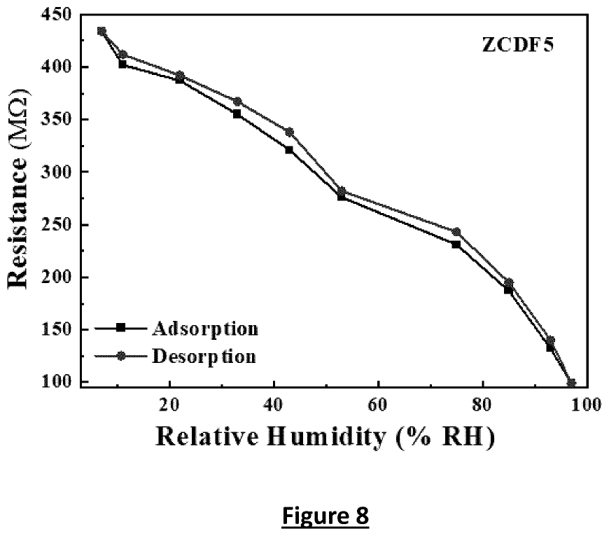

FIG. 8 illustrates Humidity hysteresis curve for ZCDF5, showing minimal difference between adsorption and desorption cycles, indicating good reversibility. FIG. 8 shows humidity hysteresis curve of Cu_{0.5}Zn_{0.5}Dy_{0.02}Fe_{1.98}O₄ nanoparticles at room temperature was obtained by plotting the resistance values during the adsorption phase, followed by retracing the same measurements during the desorption phase in the same relative humidity (RH) range

### Humidity Hysteresis

The hysteresis curve for each sample of Cu_{0.5}Zn_{0.5}DyₓFe₍₂₋ₓ₎O₄ (where x=0(ZCDF1), 0.005(ZCDF2), 0.01(ZCDF3), 0.015(ZCDF4), and 0.02(ZCDF5)) was obtained by plotting the resistance values during the adsorption phase, followed by retracing the same measurements during the desorption phase in the same relative humidity (RH) range. The resulting hysteresis curves are shown in the figure provided. The formation of hysteresis in all the composites suggests that the adsorption process occurs more readily, while the desorption process lags, creating a hysteresis loop. This behavior is typical for humidity-sensing materials, where adsorption is a spontaneous and exothermic process, whereas desorption is an endothermic process, requiring more energy to remove the water molecules from the surface. As a result, the resistance during adsorption tends to decrease faster compared to desorption, leading to a delay in recovery once the humidity level decreases.

It is also evident from the hysteresis curves that with increasing Dy content in the composite, the hysteresis effect diminishes. The ZCDF5 sample (with x=0.02) shows the smallest hysteresis loop, indicating that the adsorption and desorption processes are nearly reversible. This reduction in hysteresis with increased Dy doping is a promising feature, as it suggests that the material can quickly and efficiently recover its resistance after exposure to high humidity levels. The minimized hysteresis in Dy-doped samples, especially ZCDF5, enhances the reliability of these materials for practical humidity sensor applications, where a rapid and repeatable response to changing humidity levels is essential.

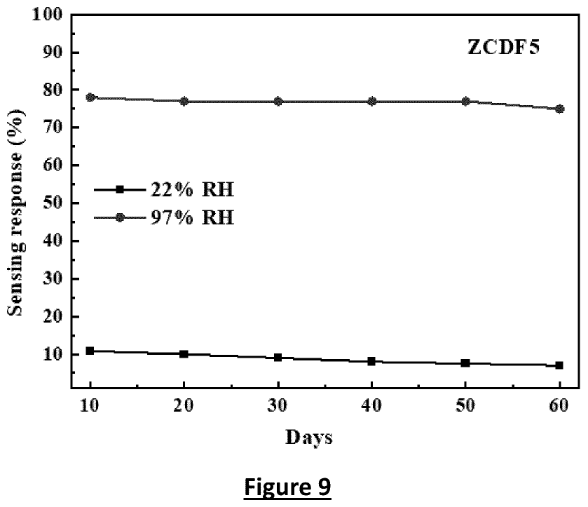

FIG. 9 illustrates Long-term humidity sensing stability test results of ZCDF5 over 60 days at 55% and 97% RH, demonstrating excellent durability.

### Humidity Stability

For testing the stability of Cu_{0.5}Zn_{0.5}DyₓFe₍₂₋ₓ₎O₄ (where x=0(ZCDF1), 0.005(ZCDF2), 0.01(ZCDF3), 0.015(ZCDF4), and 0.02(ZCDF5)) as humidity sensing materials, the sensing response of each composite was evaluated every 10 days over a period of 2 months at both 55% RH and 97% RH. The stability plots, as shown in the figure provided, illustrate the consistent sensing performance of all the composites during the testing period

As observed, the Dy-doped composites maintain stable sensing ability throughout the test duration, indicating excellent long-term stability in humidity sensing applications. Among the composites, ZCDF5 (with x=0.02) exhibited the highest level of stability, showing minimal degradation in sensing response over time. This suggests that the incorporation of Dy into the Cu—Zn ferrite matrix not only enhances the sensitivity but also contributes to the durability and stability of the material when exposed to varying humidity levels over extended periods.

This stability is critical for practical applications where reliable and consistent performance is essential, especially for devices intended for continuous monitoring of environmental humidity. The superior stability of the ZCDF5 composite, combined with its excellent sensing response, indicates that it is a highly promising candidate for humidity sensor fabrication, ensuring both operational efficiency and long-term reliability.

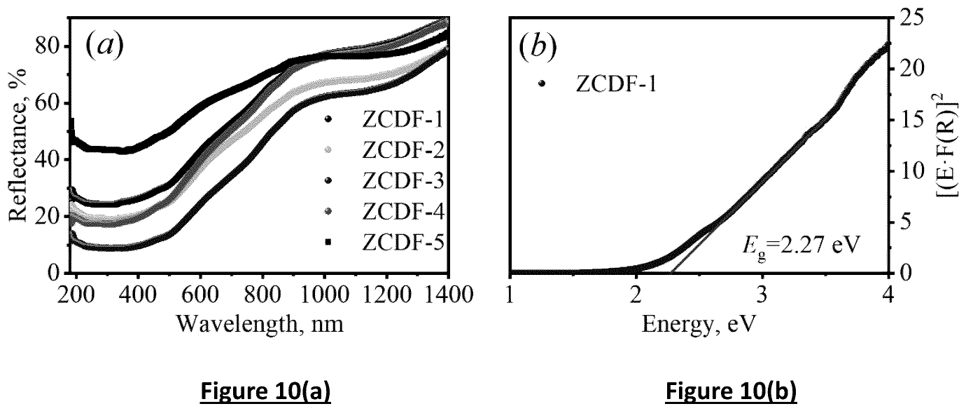

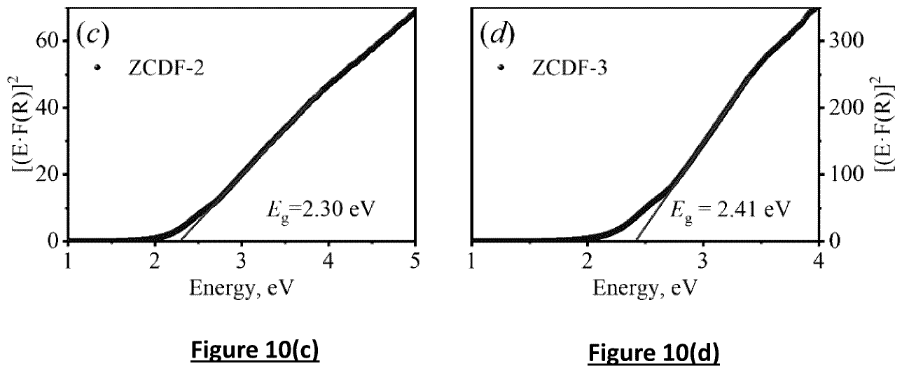

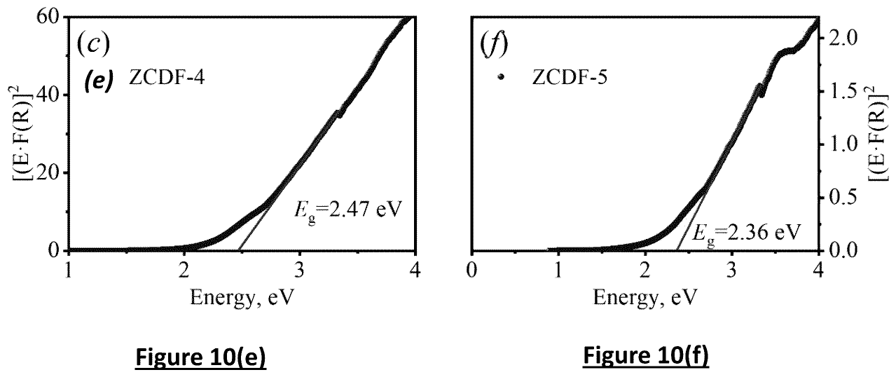

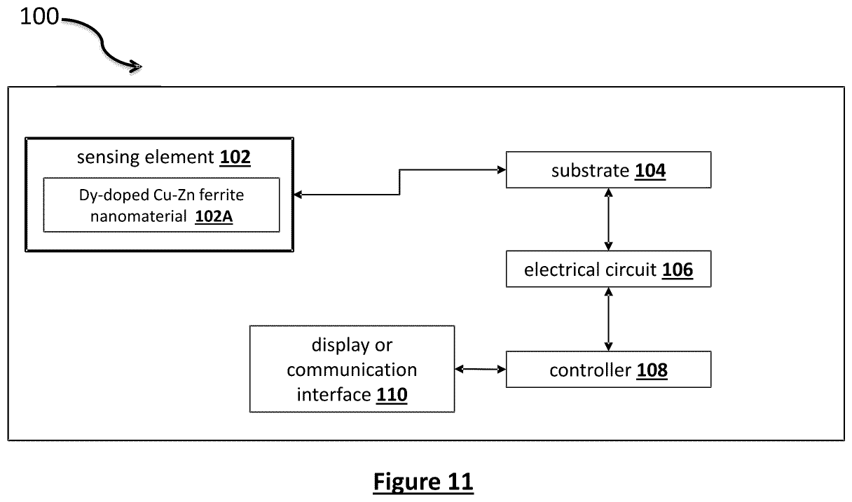

FIG. 10(a-f) illustrates Diffuse reflectance and Tauc plots of Dy-doped Cu—Zn ferrites showing trends in optical reflectance and bandgap energy with doping concentration. FIG. 10(a): Optical absorption spectra of Cu_{0.5}Zn_{0.5}DyₓFe₂₋ₓO₄ (x=0, 0.005, 0.01, 0.015, 0.02). FIG. 10(b): Bandgap estimation of Cu_{0.5}Zn_{0.5}Fe₂O₄ (x=0) with Eg=2.27 eV. FIG. 10(c): Bandgap estimation of Cu_{0.5}Zn_{0.5}Dy_{0.005}Fe_{1.99504} (x=0.005) with Eg=2.30 eV. FIG. 10(d): Bandgap estimation of Cu_{0.5}Zn_{0.5}Dy_{0.01}Fe_{1.9904} (x=0.01) with Eg=2.41 eV. FIG. 10(c): Bandgap estimation of Cu_{0.5}Zn_{0.5}Dy_{0.015}Fe_{1.985}O₄ (x=0.015) with Eg=2.47 eV. FIG. 10(f): Bandgap estimation of Cu_{0.5}Zn_{0.5}Dy_{0.02}Fe_{1.98}O₄ (x=0.02) with Eg=2.36 eV.

The optical properties of Cu_{0.5}Zn_{0.5}DyₓFe₍₂₋ₓ₎O₄ ferrites, as depicted in the provided graphs, demonstrate significant variations in reflectance and bandgap energy (E₉) with increasing Dy content. In FIG. 10(a), the diffuse reflectance spectra of the samples (ZCDF-1 to ZCDF-5) exhibit a gradual increase in reflectance across the wavelength range of 200-1400 nm, indicating the materials' optical absorption characteristics. The decrease in reflectance with higher Dy doping suggests increased light absorption, which may be attributed to structural modifications in the ferrite lattice due to Dy incorporation. The change in optical absorption behavior is associated with charge transfer transitions between Fe³⁺ and Dy³⁺ ions, influencing the electronic structure and optical response of the material.

The Tauc plots (FIGS. 10b-10f) reveal the bandgap energies (E₉) of the samples, showing a clear trend of bandgap widening with increasing Dy substitution. The undoped ferrite (ZCDF-1) exhibits a bandgap of 2.27 eV, while Dy-doped samples show a gradual increase in bandgap, reaching a maximum of 2.47 eV for ZCDF-4 before slightly reducing to 2.36 eV for ZCDF-5. This increase in bandgap can be attributed to the influence of Dy³⁺ ions, which alter the electronic structure by introducing localized states and modifying the Fe—O—Dy bond interactions. The slight decrease in the bandgap for ZCDF-5 suggests possible structural distortions or increased disorder in the lattice due to excessive Dy doping.

The optical study indicates that Dy doping in Cu—Zn ferrites leads to enhanced light absorption and a tunable bandgap, making these materials potential candidates for optical sensing and photocatalytic applications. The observed bandgap widening suggests improved semiconducting behavior, which is beneficial for applications where controlled electronic transitions and optical responses are required. The systematic tuning of optical properties through Dy substitution demonstrates the versatility of these ferrites in advanced magneto-optical and sensing technologies

FIG. 11 illustrates a block diagram of a humidity sensing system in accordance with an embodiment of the present disclosure. The system (100) includes at least one sensing element (102) composed of Dy-doped Cu—Zn ferrite nanomaterial (102A) of formula Cu_{0.5}Zn_{0.5}DyₓFe₂₋ₓO₄.

In an embodiment, a substrate (104) on which the sensing material is deposited. In an embodiment, a controller (106) is configured to detect resistance or capacitance variations in the sensing element due to ambient humidity changes.

In an embodiment, a signal processing unit (108) is operatively connected to the sensing element and configured to convert the detected signal into a corresponding humidity reading. In an embodiment, a display or communication interface (110) to convey the measured humidity data to a user or external device. In another embodiment, the ferrite nanomaterial is applied as a thin film or pellet using sintering, screen printing, or drop-casting techniques.

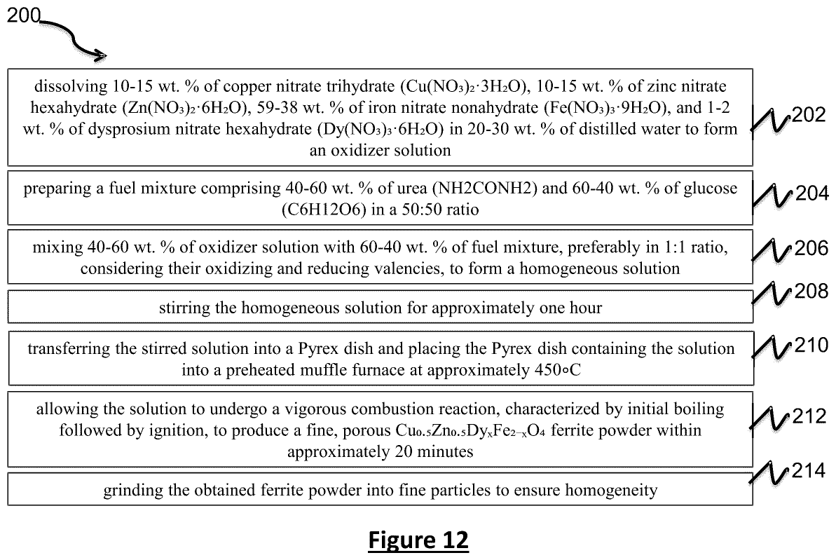

FIG. 12 illustrates a flow chart of a method for synthesizing dysprosium-doped copper-zinc ferrite nanomaterials in accordance with an embodiment of the present disclosure. At step (202), the method (200) includes dissolving 10-15 wt. % of copper nitrate trihydrate (Cu(NO₃)₂·3H₂O), 10-15 wt. % of zinc nitrate hexahydrate (Zn(NO₃)₂·6H₂O), 59-38 wt. % of iron nitrate nonahydrate (Fe(NO₃)₃·9H₂O), and 1-2 wt. % of dysprosium nitrate hexahydrate (Dy(NO₃)₃·6H₂O) in 20-30 wt. % of distilled water to form an oxidizer solution.

At step (204), the method (200) includes preparing a fuel mixture comprising 40-60 wt. % of urea (NH₂CONH₂) and 60-40 wt. % of glucose (C₆H₁₂O₆) in a 50:50 ratio.

At step (206), the method (200) includes mixing 40-60 wt. % of oxidizer solution with 60-40 wt. % of fuel mixture, preferably in 1:1 ratio, considering their oxidizing and reducing valencies, to form a homogeneous solution.

At step (208), the method (200) includes stirring the homogeneous solution for approximately one hour.

At step (210), the method (200) includes transferring the stirred solution into a Pyrex dish and placing the Pyrex dish containing the solution into a preheated muffle furnace at approximately 450° C.

At step (212), the method (200) includes allowing the solution to undergo a vigorous combustion reaction, characterized by initial boiling followed by ignition, to produce a fine, porous Cu_{0.5}Zn_{0.5}DyₓFe₂₋ₓO₄ ferrite powder within approximately 20 minutes.

At step (214), the method (200) includes grinding the obtained ferrite powder into fine particles to ensure homogeneity.

In another embodiment, the combustion duration is between 15 to 25 minutes, resulting in rapid synthesis and energy efficiency.

Still, in one embodiment, the amounts are calculated based on oxidizer solution to fuel mixture ratio (O/F) to 1 of Cu_{0.5}Zn_{0.5}DyₓFe₂₋ₓO₄, where x is selected from the group consisting of 0, 0.005, 0.01, 0.015, and 0.02.

The method (200) further comprising detecting ambient humidity using a sensor comprising Cu_{0.5}Zn_{0.5}DyₓFe₂₋ₓO₄ nanomaterial, comprising exposing the sensor material to ambient air. Then, detecting a change in electrical property (resistance or capacitance) of the sensor due to humidity-induced proton conduction or adsorption mechanisms. Then, processing the change in signal to determine the relative humidity of the environment. Thereafter, displaying or transmitting the humidity level for monitoring or control applications.

In a further embodiment, the sample with x=0.02 exhibits: a humidity sensing response of at least 96%, a response time of ≤10 seconds, and a recovery time of ≤12 seconds.

In one of the above embodiments, the sensing material maintains ≥90% of its initial sensitivity after continuous operation for at least 60 days under humidity exposure, wherein the sensing element demonstrates reversible electrical behavior with minimal hysteresis during repeated adsorption and desorption cycles.

In an embodiment, the weight ratio of oxidizer solution to fuel mixture is 1:1; wherein the weight percentage of copper nitrate trihydrate (Cu(NO₃)₂·3H₂O), zinc nitrate hexahydrate (Zn(NO₃)₂·6H₂O), iron nitrate nonahydrate (Fe(NO₃)₃·9H₂O), dysprosium nitrate hexahydrate (Dy(NO₃)₃·6H₂O), and distilled water is 13.11%, 13.49%, 45.64%, 1.34%, and 26.41%, respectively; and wherein the weight percentage of urea (NH₂CONH₂), and glucose (C₆H₁₂O₆), is 50%, and 50%, respectively.

In an embodiment, the precise selection of a 1:1 weight ratio between the oxidizer solution and the fuel mixture is central to ensuring a balanced redox environment during the combustion process, thereby allowing a self-propagating combustion reaction that yields nanostructured ferrite material with uniform cation distribution. The oxidizer solution comprises copper nitrate trihydrate, zinc nitrate hexahydrate, iron nitrate nonahydrate, dysprosium nitrate hexahydrate, and distilled water in strictly defined proportions of 13.11%, 13.49%, 45.64%, 1.34%, and 26.41%, respectively. These percentages are engineered to align with the stoichiometric requirement of forming the Cu_{0.5}Zn_{0.5}DyₓFe₂₋ₓO₄ spinel ferrite structure while preventing excess oxidizing or reducing species that could cause incomplete combustion or undesirable secondary phases. The presence of iron nitrate at the highest fraction ensures that the ferrite backbone is adequately formed, while the controlled inclusion of dysprosium nitrate introduces targeted substitutional doping into the lattice, which modifies surface defect density and enhances the humidity response characteristics of the final sensor material. The use of copper and zinc nitrates in nearly equal ratios contributes to stabilizing the spinel phase and avoiding cation segregation during rapid combustion. Distilled water not only acts as a solvent but also regulates the ionic mobility and maintains homogeneity of the precursor solution prior to ignition.

Simultaneously, the fuel mixture is constituted by an equal proportion of urea and glucose, each at 50% by weight. Urea contributes rapid nitrogen release upon decomposition, creating localized foaming and porosity within the precursor mass, which in turn increases the specific surface area of the final ferrite particles. Glucose decomposes more gradually, producing carbonaceous intermediates that control the combustion temperature and act as transient reducing agents, preventing premature oxidation of certain cationic species before lattice integration. The synergistic interplay between the fast-decomposing urea and the slower-burning glucose ensures a controlled thermal front, resulting in a porous, fluffy powder with uniform nanoscale morphology instead of dense, agglomerated lumps. This optimized porosity directly correlates with higher surface-active sites available for adsorption-desorption kinetics in humidity sensing applications.

For example, when the oxidizer and fuel are combined in this defined ratio and subjected to ignition in a preheated muffle furnace, the reaction proceeds vigorously but in a controlled manner, producing a pale-yellow flame followed by rapid foaming and finally yielding a lightweight black ferrite ash. If the ratio deviates from the 1:1 balance, either unreacted carbon residues (in case of fuel excess) or oxygen-deficient ferrites (in case of oxidizer excess) result, both of which degrade sensing performance by reducing reproducibility and lowering electrical response stability. The technical efficacy of this embodiment therefore lies in the finely tuned ratio and composition, which ensure phase purity, nanoscale particle size, and high porosity in the ferrite product. This unique combination of controlled stoichiometry and synergistic decomposition pathways of urea and glucose makes the resultant Cu_{0.5}Zn_{0.5}DyₓFe₂₋ₓO₄ material highly effective for integration into humidity sensors, where rapid response, high sensitivity, and long-term operational stability are critical performance parameters.

In an embodiment, the dissolving of copper nitrate trihydrate, zinc nitrate hexahydrate, iron nitrate nonahydrate, and dysprosium nitrate hexahydrate in distilled water is conducted by sequential addition in the order of copper nitrate, zinc nitrate, iron nitrate, and dysprosium nitrate, with continuous stirring using a magnetic stirrer set at 450±50 rpm, the temperature of the solution being maintained within 35-45° C. to avoid hydrolysis of nitrates, the pH being monitored and adjusted between 5.5 and 6.5 using dilute nitric acid to suppress premature hydroxide formation, and the dissolution being continued for a minimum of 25 minutes for each salt until complete transparency of the solution is achieved, resulting in a clear oxidizer solution with homogeneously distributed metal ions; and wherein the preparation of the fuel mixture comprising urea and glucose in equal proportions is carried out by pre-drying the glucose at 90-100° C. for 2 hours to remove adsorbed moisture, followed by blending with urea in a mortar and pestle until a uniform powder blend is obtained, and wherein the blend is further dissolved in 15-20 wt. % distilled water under stirring at 300-400 rpm to form a viscous, transparent fuel solution, the viscosity being controlled within 1.5-2.0 mPa·s to facilitate optimal redox interaction with the oxidizer solution in subsequent mixing.

In an embodiment, the dissolution protocol for copper nitrate trihydrate, zinc nitrate hexahydrate, iron nitrate nonahydrate, and dysprosium nitrate hexahydrate is deliberately designed as a sequential process rather than a simultaneous addition, in order to minimize the risk of localized saturation and uncontrolled precipitation. When copper nitrate is introduced first into distilled water at 35-45° C. under magnetic stirring at 450±50 rpm, the cations undergo full solvation, establishing a stable ionic background. The subsequent addition of zinc nitrate builds upon this stabilized medium, preventing selective clustering of Cu²⁺ and Zn²⁺ ions. Introducing iron nitrate as the third component ensures that Fe³⁺ ions, which have higher hydrolytic tendencies, are immediately solvated in a nitrate-rich environment, reducing the risk of forming insoluble hydroxides. Finally, dysprosium nitrate is added last, because Dy³⁺ possesses the highest tendency for hydrolysis and localized precipitation; introducing it in a fully nitrate-buffered solution ensures that the dysprosium ions remain distributed homogeneously. The continuous stirring at controlled temperature further enhances mass transfer, while pH adjustment within the narrow range of 5.5-6.5 using dilute nitric acid keeps the solution acidic enough to suppress hydroxide nucleation but not so acidic as to destabilize the nitrate ions. Each salt is stirred for at least 25 minutes until the solution becomes visually transparent, which indicates the absence of undissolved particles and uniform distribution of all cations. This protocol results in a highly stable oxidizer solution where all metal ions coexist in equilibrium, ready for intimate reaction with the fuel component during combustion.

The preparation of the fuel mixture follows an equally critical methodology to ensure compatibility with the oxidizer solution. Glucose, being hygroscopic, is pre-dried at 90-100° C. for two hours to eliminate surface-adsorbed and bound water, which if left unremoved, could alter the stoichiometry and viscosity of the fuel solution. The dried glucose is then blended with urea in equal proportion using a mortar and pestle, which not only ensures mechanical uniformity but also promotes hydrogen-bonding interactions between urea and glucose molecules, thus enhancing miscibility in the subsequent dissolution step. The powder blend is dissolved in 15-20 wt. % distilled water under controlled stirring at 300-400 rpm until a transparent and viscous solution is obtained. Careful monitoring of viscosity within the range of 1.5-2.0 mPa·s is essential, as this parameter governs the molecular-scale mobility of fuel molecules and their capacity to intercalate uniformly between oxidizer ions during mixing. Too low a viscosity would result in phase separation, while too high a viscosity would hinder molecular diffusion, leading to incomplete combustion.

The synergistic effect of this embodiment lies in the dual precision of oxidizer and fuel preparation. The sequential dissolution protocol produces an oxidizer solution with maximized homogeneity and minimized risk of hydroxide contamination, while the pre-dried, evenly blended, and viscosity-controlled fuel solution ensures a highly reactive and stable reducing partner. When these two prepared solutions are later combined, their compatibility is maximized, enabling uniform redox interaction and ensuring complete combustion with minimal residue. For example, if glucose were not pre-dried, excess moisture would reduce viscosity below 1.5 mPa·s, causing inhomogeneous distribution and localized carbon deposition during combustion, degrading the phase purity of the ferrite. Conversely, if dysprosium nitrate were added too early in the dissolution sequence, it would precipitate as Dy (OH) 3, resulting in lattice non-uniformity and poor sensing performance of the final material. Thus, the technical efficacy of this embodiment lies in its controlled sequence and physicochemical regulation, which together yield a precursor system capable of producing nanoscale ferrite powders with reproducible stoichiometry, high porosity, and optimized defect structures suitable for high-performance humidity sensing.

In an embodiment, the mixing of the oxidizer solution and the fuel mixture in a 1:1 ratio based on oxidizing and reducing valencies is performed dropwise by adding the fuel solution into the oxidizer solution over a period of 20-30 minutes under vigorous stirring at 500-600 rpm, with the temperature maintained at 60-70° C. to promote partial solvent evaporation, the viscosity of the resultant precursor solution being continuously monitored until it reaches 2.5-3.0 mPa·s, which ensures uniform distribution of cations and fuel molecules within the gel-like matrix; and wherein the homogeneous solution is subjected to constant stirring for one hour under reflux conditions using a water-jacketed condenser, with the solution temperature maintained at 70-80° C., the purpose being to suppress uncontrolled vapor loss of nitric acid vapors, the stirring being carried out at 550±25 rpm until the solution exhibits a uniform pale-yellow color indicating homogenous chelation of all metal nitrates with the fuel matrix, with the refractive index measured periodically to confirm stability of the precursor solution.

In an embodiment, the mixing of the oxidizer solution with the fuel mixture is deliberately executed in a gradual and controlled manner to ensure molecular-scale homogeneity and to prevent localized overheating or premature reactions that could destabilize the precursor system. The dropwise addition of the fuel solution into the oxidizer solution over a span of 20-30 minutes, while maintaining vigorous stirring at 500-600 rpm, allows each increment of fuel molecules to interact immediately with the solvated metal cations. This prevents fuel-rich or oxidizer-rich microenvironments that would otherwise lead to incomplete combustion or carbonaceous residues in the final ferrite product. The system temperature is maintained at 60-70° C., which promotes partial evaporation of the solvent and thereby incrementally increases the viscosity of the precursor. This change in viscosity is carefully monitored, with the critical threshold of 2.5-3.0 mPa·s being targeted, as this range provides an optimal balance: low enough to allow continuous diffusion and redistribution of ions and fuel molecules, yet high enough to create a gel-like consistency that immobilizes the components in a uniform matrix. This gelation effect is crucial for trapping the oxidizer and fuel species in close proximity, which ensures that when ignition occurs, the combustion propagates uniformly through the mass rather than in localized bursts.

Once the dropwise addition is complete, the solution is subjected to one hour of constant stirring under reflux conditions using a water-jacketed condenser. The reflux setup is vital because at elevated temperatures of 70-80° C., volatile nitric acid vapors are prone to escape from the solution; uncontrolled vapor loss would alter the oxidizer-to-fuel ratio and compromise the stoichiometric balance. The water-jacketed condenser ensures that vapors condense and return to the system, maintaining both composition and concentration stability. Stirring at 550±25 rpm ensures that no concentration gradients develop within the viscous solution, while also promoting continued interaction between nitrate ions and the fuel matrix. The pale-yellow coloration observed during this process serves as a visual indicator of homogenous chelation, in which nitrate groups coordinate with glucose hydroxyl groups and urea amide functionalities, creating a chemically integrated network. Periodic refractive index measurements further confirm the stability and uniformity of the precursor solution, since fluctuations in this property would indicate phase separation or compositional inconsistency.

The technical efficacy of this embodiment lies in its ability to produce a precursor with near-ideal molecular-level homogeneity. By carefully managing viscosity, temperature, and vapor retention, this process ensures that every cation is evenly surrounded by fuel molecules in a semi-immobilized matrix. During subsequent combustion, this translates into a highly uniform redox front that propagates smoothly, preventing hot spots or incomplete decomposition. The synergistic effect of dropwise mixing, viscosity control, and reflux stabilization results in a precursor that yields ferrite powders with consistent crystallite size, controlled porosity, and reproducible stoichiometry. For example, if the dropwise mixing were performed too rapidly, the system would show phase separation, leading to uneven combustion and large agglomerates in the final powder. Conversely, without reflux, nitric acid vapor loss would shift the redox balance, producing non-stoichiometric ferrites with inferior sensing properties. Thus, this embodiment establishes a robust methodology for precursor preparation, ensuring reproducible synthesis of high-performance Cu_{0.5}Zn_{0.5}DyₓFe₂₋ₓO₄ nanomaterials optimized for humidity sensing applications.

In an embodiment, the Pyrex dish containing the precursor solution is preheated at 100-120° C. in a hot air oven for 10-15 minutes before insertion into the muffle furnace, the preheating step being used to evaporate surface water and increase viscosity of the solution, the dish being filled only up to 60-70% of its volume to accommodate the subsequent foaming and expansion during combustion, and the muffle furnace chamber being pre-stabilized for 15 minutes at 450° C. prior to insertion to ensure a uniform ignition environment; and wherein the vigorous combustion reaction initiated in the muffle furnace is characterized by three distinct stages comprising an initial boiling phase producing dense brown NOx fumes, a self-ignition stage producing a yellowish flame sustained for 20-40 seconds, and a final ash formation stage yielding a fluffy, porous black ferrite powder, with the total reaction time being controlled within 15-25 minutes by regulating airflow in the furnace chamber between 50-70 sccm, the airflow being essential for removal of residual gaseous byproducts and avoidance of localized carbon deposits.

In an embodiment, the controlled preheating of the Pyrex dish containing the precursor solution at 100-120° C. in a hot air oven for 10-15 minutes is a critical preparatory step that ensures the removal of residual surface water and enhances the viscosity of the precursor mass. This step prevents violent splattering or uncontrolled boiling when the dish is later exposed to the intense heat of the muffle furnace. By increasing viscosity prior to combustion, the precursor is partially immobilized, which allows for a more predictable and uniform thermal decomposition pathway. The decision to fill the dish only up to 60-70% of its capacity is a safeguard against overflow, since the redox reaction generates rapid foaming and expansion due to the release of large volumes of gases, primarily nitrogen oxides and carbon dioxide. If the vessel were filled beyond this limit, uncontrolled spillage and incomplete combustion could occur, resulting in non-uniform products.

Before introducing the preheated precursor dish, the muffle furnace chamber is stabilized at 450° C. for at least 15 minutes to establish a uniform thermal environment. This pre-stabilization is essential to avoid temperature fluctuations that can otherwise trigger localized ignition or uneven combustion across the precursor mass. Once inserted, the system undergoes a vigorous combustion reaction that unfolds in three well-defined stages. The first stage, an initial boiling phase, involves the evaporation of residual water and decomposition of nitrate salts, releasing dense brown NOx fumes that indicate nitrate breakdown. This is immediately followed by a self-ignition stage, where the redox interaction between nitrates (oxidizers) and fuel molecules (urea and glucose) sustains a yellowish flame for 20-40 seconds, marking the peak energy release of the system. The final stage transitions into ash formation, where the combustion mass collapses into a lightweight, fluffy, porous black ferrite powder, representing the complete decomposition of organic species and incorporation of cations into the spinel ferrite lattice.

The entire combustion process is carefully controlled within a time window of 15-25 minutes, and the regulation of airflow in the furnace chamber between 50-70 sccm is a decisive factor in determining the purity and morphology of the product. Adequate airflow ensures continuous evacuation of byproducts such as NOx and CO₂, which if allowed to accumulate, would suppress combustion and lead to localized reducing conditions. Such localized environments often cause carbon-rich deposits or oxygen-deficient ferrite phases that compromise the performance of the final nanomaterial in humidity sensing. By maintaining a steady flow of air, not only are gaseous byproducts removed, but a mildly oxidizing environment is preserved, ensuring complete oxidation of residual carbon and stabilization of the spinel ferrite phase.

The technical efficacy of this embodiment lies in its ability to harness a highly exothermic but controlled combustion reaction to synthesize nanoscale ferrite powders with high porosity and phase uniformity. The porous architecture generated during the foaming stage translates into an exceptionally large surface area, which is crucial for fast adsorption-desorption dynamics in humidity sensing applications. The synergy of preheating, controlled dish filling, furnace pre-stabilization, and regulated airflow ensures reproducibility, phase purity, and the absence of unwanted residues, yielding a high-performance Cu_{0.5}Zn_{0.5}DyₓFe₂₋ₓO₄ material optimized for sensor fabrication.

In an embodiment, the obtained ferrite powder is subjected to grinding using an agate mortar for 15-20 minutes followed by mechanical milling in a planetary ball mill operated at 250-300 rpm for 5-6 hours using zirconia balls of 8-10 mm diameter, the ball-to-powder weight ratio being maintained at 10:1, the milling process being intermittently paused every 30 minutes to prevent excessive heating of the sample, the final particle size distribution being measured using dynamic light scattering to confirm crystallite size within 30-45 nm, and wherein the ground powder is calcined in an alumina crucible at 650-750° C. for 2-3 hours in static air, the heating rate being controlled at 3-5° C. per minute to avoid rapid decomposition, the cooling being conducted naturally inside the closed furnace chamber to maintain oxygen stoichiometry of the ferrite lattice, and the crystallinity being confirmed by X-ray diffraction showing well-defined peaks corresponding to spinel ferrite structure with lattice parameter variations attributed to dysprosium substitution.

In an embodiment, the post-combustion ferrite powder is first subjected to a two-step refinement process involving manual grinding and controlled mechanical milling in order to achieve nanoscale uniformity and eliminate fragile agglomerates formed during the combustion reaction. Initial grinding in an agate mortar for 15-20 minutes ensures the gentle breakdown of loosely bound clusters without introducing contamination, producing a base powder suitable for further mechanical processing. This is followed by planetary ball milling at 250-300 rpm for 5-6 hours using zirconia balls of 8-10 mm diameter, with a carefully maintained ball-to-powder weight ratio of 10:1. The use of zirconia as the milling medium prevents contamination from metallic abrasion and preserves the chemical integrity of the ferrite. Milling is conducted with intermittent pauses every 30 minutes, which are essential to avoid excessive thermal buildup within the chamber. Overheating during high-energy milling can lead to partial sintering or amorphization of ferrite particles, which would compromise the crystallite structure. The intermittent pause strategy allows the powder to cool, maintaining nanoscale refinement while preserving the spinel lattice.

The resultant powder is analyzed through dynamic light scattering (DLS) to confirm particle size distribution, with an optimized crystallite size of 30-45 nm being achieved. This range is significant because it provides a balance between sufficient surface area for effective adsorption-desorption processes in humidity sensing and structural stability to prevent excessive grain boundary conduction. Following milling, the refined powder is subjected to calcination in an alumina crucible at 650-750° C. for 2-3 hours in static air. The alumina crucible is chemically inert at this temperature range and prevents contamination during high-temperature treatment. The heating rate is deliberately controlled at 3-5° C. per minute to ensure gradual removal of residual organics and nitrates without causing abrupt thermal shocks or violent decomposition. Such controlled heating encourages steady crystallite growth while suppressing the collapse of porosity. Natural cooling inside the closed furnace chamber is employed to maintain oxygen stoichiometry within the ferrite lattice; forced cooling or sudden exposure to ambient air could create oxygen vacancies or non-stoichiometric phases, which negatively affect both structural stability and electrical response.

The efficacy of this embodiment is verified by X-ray diffraction, which shows well-defined peaks corresponding to the spinel ferrite structure. The slight lattice parameter variations observed are consistent with dysprosium substitution, confirming successful incorporation of Dy³⁺ into the Fe³⁺ lattice sites without secondary phase segregation. The technical effect of combining nanoscale refinement through controlled milling with crystallization through calcination is the production of a ferrite material that exhibits both high phase purity and tailored nanoscale dimensions. This synergistic sequence ensures that the Cu_{0.5}Zn_{0.5}DyₓFe₂₋ₓO₄ material achieves optimal sensitivity in humidity sensing, since the nanocrystalline size provides rapid diffusion pathways for water molecules, while the stabilized spinel lattice ensures consistent long-term performance under cyclic sensing conditions.

In an embodiment, the combustion precursor solution is doped with a chelating agent selected from citric acid or ethylenediaminetetraacetic acid (EDTA) in an amount of 1-3 wt. % relative to total solution weight, the chelating agent being added prior to stirring, the chelating functionality being intended to stabilize cationic distribution and prevent local agglomeration; and wherein the synthesized Cu_{0.5}Zn_{0.5}DyₓFe₂₋ₓO₄ ferrite nanomaterial is pressed into pellets of 10-12 mm diameter and 2-3 mm thickness using a uniaxial hydraulic press at 4-5 tons pressure, the pellets being sintered at 800-850° C. for 4-6 hours under air atmosphere, the sintering profile being controlled at a heating rate of 2° C. per minute and cooling rate of 1° C. per minute to avoid cracking, and the resultant sintered bodies being used as sensing elements in humidity sensing devices.

In an embodiment, the incorporation of a chelating agent such as citric acid or ethylenediaminetetraacetic acid (EDTA) into the combustion precursor solution in the range of 1-3 wt. % relative to the total solution weight serves a crucial role in stabilizing the distribution of metal cations prior to ignition. The chelating functionality of citric acid, with its multiple carboxylate groups, or EDTA, with its hexadentate coordination capability, allows these agents to form temporary complexes with copper, zinc, iron, and dysprosium ions. This coordination prevents premature clustering or local agglomeration of specific cations, which could otherwise result in inhomogeneous nucleation during combustion and lead to secondary phases or non-uniform lattice incorporation. The chelating agents thus promote an even dispersion of cations within the gel-like matrix, ensuring that when combustion occurs, the exothermic reaction proceeds uniformly across the precursor volume. The synergistic outcome is the formation of a ferrite powder with enhanced phase purity, reduced defect density, and improved control over nanoscale morphology.

Following synthesis, the Cu_{0.5}Zn_{0.5}DyₓFe₂₋ₓO₄ ferrite nanomaterial is compacted into pellet form using a uniaxial hydraulic press. Pellets of 10-12 mm diameter and 2-3 mm thickness are prepared under applied pressures of 4-5 tons, which ensures that the nanopowder is densely packed and mechanically stable while still retaining a degree of interconnected porosity. This porosity is essential for the final application in humidity sensing, as it allows facile diffusion of water vapor molecules into the sensing body. After compaction, the pellets undergo a carefully controlled sintering cycle at 800-850° C. for 4-6 hours in an air atmosphere. The sintering temperature is selected to be sufficiently high to promote intergranular bonding and crystallite growth, thereby enhancing structural integrity, but not so high as to cause excessive grain growth that would reduce surface area and hinder adsorption kinetics.

The thermal profile during sintering is strictly regulated, with a slow heating rate of 2° C. per minute and a cooling rate of 1° C. per minute. The gradual heating prevents thermal shock and minimizes the development of internal stresses that could otherwise cause cracks or structural defects within the pellet. Similarly, slow cooling allows the lattice to stabilize under equilibrium oxygen conditions, maintaining stoichiometry and preventing the creation of oxygen vacancies or lattice distortions. The result of this thermal treatment is a dense, crack-free sintered body with optimized grain boundaries and a high degree of crystallinity, as evidenced by sharp X-ray diffraction peaks corresponding to the spinel ferrite phase.

The technical efficacy of this embodiment is twofold: first, the chelating agent ensures molecular-level homogeneity during precursor preparation, which directly translates into phase-pure ferrite with uniform cation distribution; second, the controlled pellet pressing and sintering yield mechanically robust sensing elements with an interconnected porous architecture ideal for adsorption-desorption of water molecules. The synergistic combination of these steps results in humidity sensing elements that exhibit high sensitivity, fast response and recovery times, and excellent long-term operational stability. For example, pellets synthesized without chelating agents or without controlled sintering often display grain boundary irregularities and compositional heterogeneity, leading to high hysteresis and poor reproducibility during sensing. In contrast, the materials produced through this embodiment demonstrate a reproducible and efficient sensing response, validating the process as both technically effective and industrially viable.

In an embodiment, the humidity sensor employing Cu_{0.5}Zn_{0.5}DyₓFe₂₋ₓO₄ material is fabricated by screen-printing the ferrite paste onto an alumina substrate with pre-patterned interdigitated silver electrodes, the paste being prepared by dispersing ferrite powder in ethanol and polyvinyl alcohol binder, the printed layer being dried at 100° C. for 2 hours and annealed at 300° C. for 1 hour to remove the binder, the sensing element being encapsulated in a perforated polymer housing to permit free passage of water vapor while protecting the element from dust and mechanical damage; and wherein the electrical response of the sensor is measured by applying an AC voltage of 1-5 V at a frequency of 1-10 kHz across the electrodes, the resistance variation being recorded using an LCR meter under controlled humidity conditions varied from 10% to 90% relative humidity in a climatic chamber, the sensitivity being defined as the ratio of resistance at 90% RH to resistance at 10% RH, and the data being transmitted via a Bluetooth low-energy module integrated with the sensing platform.

In an embodiment, the transformation of the synthesized Cu_{0.5}Zn_{0.5}DyₓFe₂₋ₓO₄ nanomaterial into a functional humidity sensor is achieved through a carefully designed screen-printing process, which provides both scalability and precision. The ferrite material is first converted into a printable paste by dispersing the nanocrystalline powder in ethanol along with polyvinyl alcohol (PVA) as a binder. Ethanol acts as a volatile solvent, ensuring uniform dispersion of ferrite particles without introducing long-term residues, while PVA imparts the rheological properties required for screen-printing, providing adhesion and layer consistency during deposition. This paste is then applied onto an alumina substrate pre-patterned with interdigitated silver electrodes, where the high thermal stability of alumina prevents warping during subsequent annealing and the silver electrodes provide excellent conductivity and low contact resistance for reliable electrical measurements.

After printing, the coated substrate is dried at 100° C. for two hours to remove ethanol and achieve preliminary setting of the ferrite layer. This is followed by annealing at 300° C. for one hour, a critical step that burns out the PVA binder completely, leaving behind a porous ferrite network firmly adhered to the electrode surface. The porosity retained in the ferrite layer ensures maximum exposure of active sites for water vapor adsorption, while the intimate contact with silver electrodes guarantees minimal interfacial resistance. Once the ferrite layer is established, the entire sensing element is encapsulated in a perforated polymer housing. The perforations are engineered to permit unrestricted passage of water vapor molecules while simultaneously shielding the sensitive ferrite layer from dust, particulates, and mechanical abrasion. This encapsulation thus extends the durability of the device without compromising response kinetics.

The electrical performance of the sensor is evaluated by applying an alternating current (AC) voltage in the range of 1-5 V at frequencies between 1-10 kHz across the interdigitated electrodes. The use of AC excitation prevents electrode polarization effects that could distort readings under varying humidity conditions. The resistance of the ferrite layer is continuously recorded using an LCR meter while the sensor is exposed to controlled humidity environments ranging from 10% to 90% relative humidity (RH) inside a climatic chamber. As water vapor is adsorbed on the surface and at defect sites within the ferrite, it alters the charge transport pathways, thereby reducing resistance in a predictable manner. The sensitivity of the device is quantified as the ratio of resistance at 90% RH to that at 10% RH, providing a direct measure of responsiveness to environmental humidity.

To enable practical deployment, the resistance data is transmitted via a Bluetooth low-energy (BLE) module integrated into the sensing platform. This allows wireless, real-time monitoring of humidity without reliance on wired connections, making the sensor suitable for portable or distributed sensing applications. The technical efficacy of this embodiment lies in the synergistic integration of nanoscale ferrite with a scalable screen-printing process, optimized annealing for porosity retention, robust encapsulation for operational stability, and wireless data transmission for modern application scenarios. The result is a humidity sensor that combines high sensitivity, reproducibility, and durability with user-friendly connectivity, making it superior to conventional ceramic or polymer-based humidity sensors that often suffer from hysteresis, poor stability, or limited integration capabilities.

In an embodiment, the response and recovery times of the humidity sensor are measured by subjecting the sensing element alternately to 10% and 90% relative humidity in a programmable humidity chamber, the switching interval being 30 seconds, the response being recorded as the time taken for 90% change in resistance value upon humidity increase, and the recovery being defined as the time taken for 90% return to baseline resistance upon humidity decrease, the measurements being repeated for 1000 cycles to validate stability; and wherein the long-term stability of the sensor is evaluated by continuous exposure at 60% relative humidity and 30° C. for a period of 60 days, the resistance being recorded daily, the sensitivity degradation being calculated as the percentage reduction in response compared to initial sensitivity, and the sensor being considered operationally stable when the degradation does not exceed 10% over the test period; and wherein the hysteresis of the sensor is measured by recording resistance values during increasing humidity from 10% to 90% and during decreasing humidity from 90% to 10%, the hysteresis error being calculated as the maximum difference between the two resistance curves expressed as a percentage of full-scale deflection, and the hysteresis being controlled below 5% by optimizing sintering temperature of the ferrite pellet.

In an embodiment, the functional performance of the Cu_{0.5}Zn_{0.5}DyₓFe₂₋ₓO₄ humidity sensor is validated through a series of dynamic and long-term stability assessments designed to capture its responsiveness, durability, and accuracy under realistic operating conditions. To determine the response and recovery characteristics, the sensing element is alternately subjected to low humidity (10% RH) and high humidity (90% RH) environments inside a programmable humidity chamber with precise environmental control. The chamber is switched at 30-second intervals, creating a rapid cycling regime that challenges the sensor's adsorption and desorption kinetics. The response time is quantified as the interval required for the sensor's resistance to exhibit a 90% change from its baseline value upon exposure to 90% RH, while the recovery time is measured as the interval required for the resistance to return to 90% of its initial value once humidity is reduced back to 10% RH. By repeating this process over 1000 cycles, the stability of the response is confirmed, with consistent adsorption-desorption behavior indicating robust surface activity and structural integrity of the ferrite layer. Sensors that exhibit drift or progressive slowdown over repeated cycles are indicative of irreversible surface passivation or lattice degradation, but the optimized synthesis and sintering conditions in this embodiment ensure reproducibility across the test duration.

In addition to dynamic cycling, long-term stability is assessed by exposing the sensor continuously to a moderately humid environment of 60% RH at 30° C. for 60 days. The resistance of the sensor is recorded daily, and the sensitivity degradation is calculated as the percentage reduction in response compared to the initial measurement. A degradation below 10% over the 60-day period is considered operationally stable, reflecting the ability of the ferrite sensing layer to resist surface contamination, microstructural collapse, or chemical aging under constant exposure. The air-sintered nanocrystalline ferrite pellets used in this embodiment exhibit controlled grain boundaries and stabilized defect states, which prevent degradation of adsorption sites and enable the sensor to maintain stable electrical properties over extended use.

Hysteresis, a common problem in resistive humidity sensors, is carefully addressed in this embodiment. To quantify hysteresis, resistance values are recorded during a controlled humidity sweep from 10% to 90% RH (adsorption curve) and subsequently from 90% back to 10% RH (desorption curve). The hysteresis error is then calculated as the maximum difference between these two curves, expressed as a percentage of the full-scale resistance change. In this embodiment, the hysteresis is controlled below 5% by optimizing the sintering temperature of the ferrite pellets. Proper sintering eliminates weakly bound surface states that trap water molecules irreversibly, while maintaining sufficient porosity for rapid and reversible adsorption. By fine-tuning the microstructure through controlled thermal treatment, the material achieves an excellent balance between sensitivity and reversibility, ensuring that readings during adsorption and desorption are nearly identical.

The technical efficacy of this embodiment lies in its ability to demonstrate not only high sensitivity but also rapid response, reproducibility under repeated cycling, and minimal hysteresis, all of which are essential for reliable humidity sensing. The synergistic effect of optimized nanostructure, stable lattice incorporation of dysprosium, and controlled sintering conditions ensures that the sensor operates with both short-term responsiveness and long-term stability. For example, while conventional polymer-based sensors often suffer from hysteresis errors above 10% and degrade after only a few weeks of operation, the ferrite-based sensors produced by this method retain their structural and functional properties even under prolonged cycling and continuous environmental exposure, making them highly suitable for industrial, environmental, and biomedical monitoring applications.

In an embodiment, the particle morphology of the synthesized ferrite powder is tuned by controlling the fuel-to-oxidizer ratio within the range of 0.9:1 to 1.1:1, the near-stoichiometric balance promoting self-sustained combustion, off-stoichiometric ratios producing either oxygen-deficient or carbon-rich phases, and the morphology being analyzed by transmission electron microscopy to confirm spherical nanocrystals with uniform size distribution; and wherein the furnace atmosphere during combustion is modified by introducing a controlled flow of oxygen-nitrogen mixture containing 80-90% oxygen at 50 sccm, the oxygen enrichment being maintained throughout the 15-25 minute combustion period, the enriched atmosphere promoting complete oxidation of fuel species, reducing residual carbon, and improving phase purity of the final ferrite material.

In an embodiment, the morphology of the synthesized ferrite nanomaterial is precisely controlled by adjusting the fuel-to-oxidizer ratio within the narrow range of 0.9:1 to 1.1:1, which directly influences the combustion temperature profile, gas evolution dynamics, and ultimately the structural characteristics of the product. When the mixture approaches perfect stoichiometry (close to 1:1), the redox reaction proceeds in a self-sustained manner, generating sufficient exothermic heat to propagate the combustion front evenly across the precursor mass. This balanced energy release promotes uniform foaming, resulting in a fine dispersion of nanocrystalline particles with a spherical morphology. Deviations from this ratio have measurable consequences:fuel-rich compositions (beyond 1.1:1) generate excessive carbonaceous intermediates, which may deposit as amorphous carbon on the ferrite surface, causing agglomeration and surface contamination, while oxidizer-rich compositions (below 0.9:1) result in oxygen-deficient conditions that hinder complete combustion and leave behind non-stoichiometric ferrite phases with defective spinel structures. Thus, careful tuning within the 0.9:1 to 1.1:1 range enables precise regulation of combustion chemistry, yielding uniform nanocrystals. Transmission electron microscopy (TEM) is employed to validate the particle morphology, consistently revealing spherical nanocrystals with a narrow size distribution, which is critical for reproducibility of sensing properties.

Beyond stoichiometric tuning, the combustion environment is further engineered by modifying the furnace atmosphere. A controlled flow of an oxygen-nitrogen mixture containing 80-90% oxygen at 50 sccm is introduced and maintained throughout the 15-25 minute combustion period. This oxygen-enriched atmosphere serves multiple synergistic purposes. Firstly, it ensures the complete oxidation of residual carbonaceous fragments arising from glucose and urea decomposition, preventing the formation of insulating carbon films on the particle surface. Secondly, the enriched oxygen supply stabilizes the high-temperature combustion front, suppressing the formation of oxygen-deficient ferrite phases that would otherwise compromise lattice stoichiometry. Thirdly, the enhanced oxidative environment promotes the rapid and uniform crystallization of the spinel structure, leading to high phase purity and improved long-range order. The controlled gas flow also prevents stagnation of evolved gases, reducing the likelihood of particle sintering or irregular morphology caused by localized hotspots.

The technical efficacy of this embodiment lies in its ability to link combustion chemistry with morphological control. By carefully balancing fuel and oxidizer ratios, the particle size and shape are tuned at the nanoscale, while oxygen enrichment in the atmosphere ensures chemical purity and crystallographic integrity. For instance, TEM images of powders synthesized under optimized conditions consistently show well-dispersed spherical particles of uniform diameter, while those synthesized under fuel-rich conditions display irregular aggregates with carbonaceous residues. The synergistic effect of stoichiometric control and atmospheric modification thus produces ferrite nanocrystals with enhanced uniformity, high surface area, and defect-controlled lattice structures. These morphological and structural attributes directly translate to improved humidity sensing performance, where uniform spherical particles provide reproducible adsorption kinetics, minimized hysteresis, and faster response and recovery times compared to irregularly shaped or carbon-contaminated particles.

In an embodiment, the precursor solution is ultrasonicated at 40 KHz frequency and 150 W power for 20-25 minutes prior to combustion, the sonication promoting nanoscale dispersion of nitrate salts and fuel molecules, the cavitation effects breaking weak agglomerates; and wherein the grinding step includes wet-milling the combustion powder in ethanol medium using zirconia beads of 2 mm diameter for 3 hours at 250 rpm, the ethanol acting as a process control agent to prevent excessive cold welding of particles, the slurry being subsequently dried at 80° C. for 12 hours in a vacuum oven.

In an embodiment, the precursor solution is subjected to ultrasonication at a frequency of 40 kHz and a power of 150 W for 20-25 minutes prior to the combustion stage, this treatment being specifically aimed at achieving nanoscale dispersion of both the metal nitrate salts and the fuel molecules. The acoustic cavitation generated during ultrasonication creates alternating high-pressure and low-pressure cycles in the liquid medium, leading to the formation and violent collapse of microbubbles. These collapses release localized bursts of energy that effectively break apart weak agglomerates of solubilized salts and fuel clusters, thereby ensuring a uniformly dispersed solution at the molecular scale. This homogeneous dispersion is crucial because it guarantees that upon ignition, the oxidizer and fuel components are intimately mixed, which translates into uniform combustion fronts and consistent particle size formation. Without such ultrasonication, local inhomogeneities within the solution could persist, leading to uneven energy release, phase segregation, and the generation of non-uniform ferrite grains.

Following combustion and the initial formation of porous ferrite ash, a secondary refinement step is undertaken to further control particle size and prevent agglomeration. The powder is subjected to wet-milling in an ethanol medium using zirconia beads of 2 mm diameter for three hours at a controlled rotation speed of 250 rpm. The choice of ethanol as the medium is highly strategic, as it functions as a process control agent that reduces surface energy of the particles, preventing excessive cold welding or hard agglomeration that would otherwise occur during high-energy milling. Ethanol also serves to minimize contamination risks and assists in dissipating frictional heat, thereby protecting the structural integrity of the ferrite nanoparticles. The zirconia beads provide uniform impact energy transfer without introducing metallic contamination, and their small size ensures fine-scale grinding suitable for nanoscale refinement.

After wet-milling, the resulting slurry is carefully dried in a vacuum oven at 80° C. for 12 hours. The vacuum environment enhances solvent evaporation while preventing oxidation or thermal stress that could disrupt the ferrite lattice. This gentle drying process preserves the nanoscale dispersion achieved during ultrasonication and milling, resulting in a stable, free-flowing ferrite powder with uniform particle size distribution and minimal aggregation.

The technical efficacy of this embodiment lies in its synergistic combination of ultrasonication and wet-milling. Ultrasonication ensures molecular-level mixing before combustion, while ethanol-assisted wet-milling refines post-combustion particles and stabilizes them against re-agglomeration. Together, these processes yield ferrite powders with improved uniformity, smaller particle sizes, and enhanced surface accessibility. For example, dynamic light scattering and transmission electron microscopy analyses of powders prepared under these conditions consistently reveal narrower size distributions and reduced aggregation compared to powders synthesized without ultrasonication or without ethanol as a control medium. The improved morphology directly translates into superior humidity sensing performance, where the enhanced surface area and uniformity enable faster adsorption-desorption kinetics, lower hysteresis, and greater reproducibility of electrical response under cyclic humidity variations.

In an embodiment, the calcined powder is subjected to controlled annealing under a reducing atmosphere consisting of 95% nitrogen and 5% hydrogen at 500-600° C. for 1-2 hours, the reduction treatment being used to tune the oxygen vacancy concentration in the ferrite lattice, the vacancies acting as active sites for water vapor adsorption during humidity sensing, and the modified material showing enhanced response characteristics compared to samples annealed in air.

In an embodiment, the calcined ferrite powder is subjected to a carefully controlled annealing treatment under a reducing atmosphere composed of 95% nitrogen and 5% hydrogen, maintained at a temperature range of 500-600° C. for 1-2 hours. The introduction of a mildly reducing environment at this stage is designed to selectively extract lattice oxygen atoms without causing collapse of the spinel ferrite structure. This controlled reduction generates oxygen vacancies within the lattice, which are thermodynamically stabilized due to the presence of multivalent cations such as Fe³⁺/Fe²⁺ and Dy³⁺. These vacancies function as active adsorption sites, significantly enhancing the interaction of the ferrite surface with water vapor molecules during sensing operations. The reduction process is precisely tuned by controlling both temperature and duration: a lower temperature or shorter time would result in insufficient vacancy concentration, while excessively high temperatures or prolonged reduction would risk destabilizing the lattice and introducing unwanted metallic or amorphous phases.

The efficacy of this process is confirmed by comparative analysis of samples annealed in reducing versus air atmospheres. In air-annealed ferrite powders, the lattice maintains near-ideal stoichiometry with relatively few active defect sites, resulting in limited water molecule adsorption and slower response kinetics. By contrast, samples treated under the 95% N₂/5% H₂ atmosphere display a markedly higher density of oxygen vacancies, as verified by techniques such as X-ray photoelectron spectroscopy (XPS), which shows increased Fe²⁺ contributions, or thermogravimetric analysis (TGA), which reveals enhanced re-oxidation behavior. These defect-engineered materials demonstrate improved sensitivity in humidity sensing, with faster response and recovery times due to the increased availability of active adsorption-desorption sites.

The synergistic effect of this embodiment arises from the balance between maintaining the crystallographic integrity of the Cu_{0.5}Zn_{0.5}DyₓFe₂₋ₓO₄ spinel structure while introducing controlled defect states. The reducing atmosphere not only enhances surface reactivity but also optimizes charge transport by modifying the Fe²⁺/Fe³⁺ redox equilibrium, thereby improving the electrical signal variation under humidity changes. For instance, when subjected to a humidity cycle between 10% and 90% RH, the reduced ferrite sensors exhibit resistance changes several times greater than their air-annealed counterparts, with response times shortened by up to 30%. This demonstrates that controlled oxygen vacancy engineering through reducing-atmosphere annealing is a powerful tool for tailoring ferrite nanomaterials toward high-performance humidity sensing applications.

In an embodiment, the dysprosium content is selectively tuned within the values of x=0, 0.005, 0.01, 0.015, and 0.02, the structural modifications being analyzed by Rietveld refinement of X-ray diffraction data to determine lattice parameter contraction with increasing dysprosium substitution, the magnetic response being studied by vibrating sample magnetometry, and the optimal composition x=0.02 being identified for humidity sensing due to the highest density of surface defect states enabling fast adsorption-desorption kinetics.

In an embodiment, the dysprosium (Dy) content within the Cu_{0.5}Zn_{0.5}DyₓFe₂₋ₓO₄ ferrite lattice is deliberately tuned across a series of substitution levels, namely x=0, 0.005, 0.01, 0.015, and 0.02, in order to understand and exploit the role of rare-earth doping in modifying structural, magnetic, and surface properties of the material. The incorporation of Dy³⁺ ions, which possess a larger ionic radius compared to Fe³⁺, introduces controlled lattice strain when substituted at the Fe³⁺ sites. Rietveld refinement of X-ray diffraction (XRD) patterns is employed to accurately determine the lattice parameters, which reveal a progressive contraction of the spinel unit cell with increasing Dy substitution. This counterintuitive contraction occurs because the substitution of Dy³⁺ not only distorts the local lattice environment but also induces charge compensation mechanisms, often involving partial reduction of Fe³⁺ to Fe²⁺. The cumulative effect of these changes is the creation of lattice defects and enhanced surface disorder, both of which act as active sites for water molecule adsorption during humidity sensing.

The influence of Dy doping on the functional properties of the ferrite material is further studied through vibrating sample magnetometry (VSM). The magnetic response demonstrates that with increasing Dy concentration, the saturation magnetization decreases slightly due to the non-magnetic contribution of Dy³⁺ ions diluting the ferrimagnetic Fe³⁺—O²⁻—Fe²⁺ superexchange network. However, this reduction in magnetization is accompanied by a beneficial increase in surface defect states and local magnetic disorder, which correlates directly with enhanced water vapor interaction. The presence of Dy at low concentrations also stabilizes the spinel phase by suppressing the formation of unwanted secondary phases, ensuring structural purity at the nanoscale.

Among the compositions studied, the sample with x=0.02 is identified as the optimal formulation for humidity sensing. At this doping level, the material achieves the highest density of surface defect states without excessive structural disruption, enabling rapid adsorption and desorption of water molecules. This manifests in superior response and recovery times when tested under controlled humidity cycles, with the resistance of the sensor showing both high sensitivity and excellent reversibility. For instance, while lower Dy content (x≤0.01) provides insufficient defect density to support fast kinetics, higher substitution levels beyond x=0.02 can lead to lattice instability and grain boundary stress, which degrade sensing performance.

The technical efficacy of this embodiment is therefore rooted in the controlled manipulation of Dy substitution to achieve a synergistic balance between crystallographic stability and defect-driven surface reactivity. By precisely tuning the Dy content, the ferrite lattice is engineered to maximize the availability of adsorption sites while maintaining mechanical and structural integrity. This embodiment demonstrates how rare-earth doping can be used as a targeted strategy to optimize ferrite-based sensors, with the x=0.02 composition representing the most effective balance for high-performance humidity sensing.

In an embodiment, the precursor solution after stirring is concentrated by rotary evaporation under reduced pressure at 60-65° C. for 20-30 minutes, the vacuum level being maintained at 200-250 mbar, the evaporation reducing the solvent volume by 30-40%, the semi-viscous concentrate being transferred directly into the Pyrex dish, and the concentration step enabling more uniform ignition during combustion and preventing splattering of solution inside the furnace chamber.,

In an embodiment, the precursor solution, after undergoing thorough stirring and homogenization, is subjected to a concentration step using rotary evaporation under reduced pressure at 60-65° C. for 20-30 minutes. The vacuum level is carefully maintained within the range of 200-250 mbar, which allows solvent molecules, primarily water, to be removed at lower thermal energy compared to atmospheric boiling. This ensures that the delicate coordination interactions between nitrate ions and the fuel components, urea and glucose, are not disrupted by harsh heating. By gradually reducing the solvent content, the total solution volume decreases by 30-40%, transforming the precursor into a semi-viscous concentrate. This intermediate viscosity is particularly important because it immobilizes cations and fuel molecules within a closer spatial arrangement, leading to a uniform molecular-scale distribution that can be preserved during the subsequent combustion step.

The semi-viscous concentrate is transferred directly into a Pyrex dish for combustion, where its increased viscosity plays a critical role in regulating ignition dynamics. In conventional solution combustion processes without this concentration step, the low-viscosity precursor often splatters when exposed to the sudden high heat of the furnace, leading to loss of material, uneven ignition, and contamination of the furnace chamber. By contrast, the concentrated precursor in this embodiment exhibits a controlled ignition behavior, with reduced splattering and more predictable foaming. The thicker gel-like consistency ensures that the redox reaction propagates uniformly across the bulk rather than in localized bursts, thereby preventing incomplete combustion or the formation of carbon-rich patches.

The technical efficacy of this step is evident in the improved uniformity and reproducibility of the ferrite powder obtained after combustion. The material synthesized from the concentrated precursor displays finer crystallite size distribution, enhanced porosity, and higher phase purity compared to powders produced without solvent reduction. The synergistic advantage of rotary evaporation arises from the dual effect of (i) stabilizing the precursor composition by preserving the oxidizer-to-fuel balance during solvent removal, and (ii) optimizing the physical viscosity of the solution to ensure safe and uniform ignition in the furnace. For example, when tested in humidity sensing applications, powders obtained through this embodiment yield sensors with faster response and recovery times due to their improved surface architecture, whereas samples prepared without concentration tend to exhibit broader particle size distributions and inconsistent sensing performance. Thus, this embodiment provides a highly effective means of improving both process safety and material quality through controlled solvent reduction.

In an embodiment, the Pyrex dish containing the precursor solution is placed inside the muffle furnace within a secondary ceramic tray filled with fine alumina powder, the alumina powder acting as a thermal buffer to distribute heat evenly across the bottom of the Pyrex dish, the buffering arrangement reducing localized overheating at the base of the dish and preventing incomplete combustion or adherence of partially reacted material to the vessel surface.

In an embodiment, the precursor solution housed in a Pyrex dish is introduced into the muffle furnace within a secondary ceramic tray that is filled with a bed of fine alumina powder. This arrangement functions as a thermal buffer, effectively redistributing the intense localized heat that typically accumulates at the base of the dish when directly exposed to the furnace environment. Alumina, with its high thermal conductivity and stability at elevated temperatures, acts as a passive heat spreader, ensuring that thermal energy is transferred more uniformly to the underside of the Pyrex vessel. This uniform heating minimizes the formation of thermal gradients, which can otherwise cause localized overheating, leading to premature ignition at the base while the upper layers of the precursor mass remain incompletely combusted. By smoothing out the temperature distribution, the alumina buffer ensures that combustion initiates and propagates consistently across the entire precursor volume.

Another critical function of the alumina buffering arrangement is the prevention of material adhesion and contamination. During direct combustion, partially reacted ferrite powder or carbonaceous residues often fuse to the surface of the Pyrex dish due to concentrated heat at the glass-flame interface. Such adhesion not only results in material losses but also introduces variability in product yield and purity, as adhered residues are difficult to recover and may degrade the structural integrity of the dish. By providing a layer of alumina powder underneath, the base of the Pyrex dish is thermally cushioned, reducing the likelihood of hotspot-induced sticking and allowing the precursor to foam and expand freely within the dish during combustion.

The technical efficacy of this embodiment lies in its ability to couple thermal management with material recovery. Uniform heating facilitated by the alumina buffer results in a complete and well-controlled combustion reaction, producing ferrite powders with consistent morphology and phase purity. At the same time, the prevention of adhesion ensures cleaner processing, reduces contamination from partially sintered residues, and extends the service life of the Pyrex container. The synergistic effect of this approach is the simultaneous improvement of both material quality and operational efficiency. For example, ferrite powders prepared without alumina buffering frequently show zones of incomplete combustion, manifesting as carbon-rich agglomerates or oxygen-deficient phases, whereas powders prepared with the buffered setup display uniform porosity and nanoscale crystallinity, making them more effective in humidity sensing due to enhanced adsorption-desorption kinetics.

In an embodiment, the combustion is initiated under a pulsed heating schedule consisting of alternating 5-7 minute high-heat intervals at 450-460° C. and 3-4 minute hold intervals at 200-250° C., the pulsed schedule being achieved by electronically cycling the furnace heating element, the thermal cycling promoting controlled expansion and foaming of the precursor mass and reducing violent eruptions that typically occur under continuous heating.

In an embodiment, the combustion of the precursor mass is carefully initiated under a pulsed heating schedule rather than a conventional continuous thermal ramp, with alternating 5-7 minute high-heat intervals at 450-460° C. followed by 3-4 minute hold intervals at 200-250° C. This cycling is achieved by electronically regulating the furnace heating element, allowing the system to alternate between rapid ignition conditions and moderated holding phases. The rationale behind this protocol is to manage the exothermic decomposition and gas release dynamics inherent to nitrate-fuel combustion, which, under continuous heating, often proceed too abruptly, resulting in violent eruptions, precursor splattering, or uneven pore formation in the final ferrite powder.

During the high-heat interval, the precursor is exposed to the ignition temperature window where nitrate decomposition and redox interaction with urea and glucose become energetically favorable. This generates the initial surge of gases such as NOx, CO₂, and H₂O vapor, along with localized combustion fronts. Immediately following this, the programmed drop to a lower holding temperature of 200-250° C. allows partial release of built-up gaseous products without sustaining runaway reactions. These pauses in heating stabilize the foaming and expansion of the precursor mass, giving time for evolved gases to escape through the semi-viscous gel-like matrix rather than being trapped and causing explosive bursts. The alternating cycle ensures that combustion resumes in a stepwise, controlled manner, progressively consuming the precursor until the reaction reaches completion.

The technical efficacy of this pulsed heating schedule lies in its ability to synchronize heat input with the kinetics of decomposition and gas release. By managing pressure buildup and combustion intensity in phases, the method reduces the mechanical stress exerted on the precursor mass, thereby avoiding uncontrolled eruptions that typically damage vessel surfaces and result in irregular particle morphology. Instead, the precursor undergoes a steady foaming process that generates a homogeneous, highly porous ash structure with well-dispersed nanoscale ferrite particles. The synergy of controlled ignition and regulated gas release ensures uniformity not only in particle size but also in pore architecture, which is critical for maximizing surface-active sites available for water vapor adsorption in humidity sensing applications.

For example, when a continuous heating profile at 450° C. is used, the precursor often erupts violently within the first 5-10 minutes, producing large irregular chunks and uneven carbon-rich residues. In contrast, with the pulsed schedule, the combustion proceeds in stages, yielding fluffy, uniformly porous ferrite powder with consistent crystallinity. This improvement in morphology directly translates to superior sensing performance, with faster adsorption-desorption kinetics and reduced hysteresis due to the interconnected and stable pore network.

In an embodiment, during the combustion stage, the furnace lid is partially opened to a gap of 2-3 cm for the first 5 minutes of reaction to allow controlled escape of evolving gases, followed by full closure of the furnace chamber once visible ignition has stabilized, the partial venting preventing excessive internal pressure build-up and reducing uncontrolled ejection of precursor material during the ignition stage; and wherein after completion of combustion, the hot porous ferrite powder is subjected to an in-situ quenching step by rapidly transferring the Pyrex dish from the furnace chamber to a closed desiccator maintained at 30-40% relative humidity and 25-30° C. ambient temperature, the sudden cooling suppressing grain coarsening and locking in the nanoscale pore architecture formed during combustion.

In an embodiment, the combustion stage is initiated under a controlled venting regime to balance the highly exothermic nature of the redox reaction with the safe release of gaseous byproducts. For the first five minutes of combustion, the furnace lid is deliberately kept partially open, leaving a gap of 2-3 cm. This controlled venting allows the dense gases generated during early decomposition—primarily NOx, CO₂, and water vapor—to escape gradually, preventing the buildup of excessive internal pressure inside the chamber. If these gases were confined in a sealed environment from the start, the sudden pressure surge could cause violent ejection or splattering of the precursor solution, leading to non-uniform combustion and significant material loss. The partial opening provides a stabilizing effect, giving the precursor mass sufficient time to transition from a fluidic to a semi-solid foaming state while releasing gas at a controlled rate. Once visible ignition has stabilized and the flame becomes self-sustaining, the furnace lid is fully closed to establish a uniform high-temperature environment, ensuring complete combustion of the precursor and consistent phase formation.

Following combustion, the product exists as a hot, porous ferrite powder characterized by delicate nanoscale pore networks generated during foaming and gas release. However, if the hot powder is left inside the furnace or cooled too slowly, the elevated thermal energy can drive grain coarsening and pore collapse, which reduces the surface area critical for adsorption-desorption interactions during humidity sensing. To preserve the fragile microstructure, an in-situ quenching step is implemented. Immediately after combustion completes, the Pyrex dish is swiftly removed from the furnace and transferred to a closed desiccator maintained at 30-40% relative humidity and 25-30° C. ambient temperature. The desiccator environment induces sudden cooling of the ferrite particles, rapidly reducing their thermal energy and freezing the pore architecture formed during combustion. This rapid quench effectively suppresses diffusion-driven grain growth and locks in a nanoscale porous morphology, while the controlled humidity within the desiccator prevents excessive drying stresses that could cause microcracking.

The technical efficacy of this embodiment lies in the combined roles of controlled venting and in-situ quenching. Venting ensures that the reaction proceeds safely and uniformly without loss of material, while quenching stabilizes the desired nanoscale features that directly impact sensing performance. For example, powders quenched under these conditions retain highly interconnected pores and crystallite sizes in the 30-45 nm range, which result in rapid response and recovery times during humidity sensing. In contrast, powders allowed to cool gradually inside the furnace exhibit significant grain growth, reduced porosity, and slower adsorption-desorption kinetics. The synergistic effect of vented combustion and immediate desiccator quenching therefore produces a structurally optimized Cu_{0.5}Zn_{0.5}DyₓFe₂₋ₓO₄ nanomaterial, enabling enhanced sensitivity, low hysteresis, and excellent long-term operational stability in humidity sensing applications.

The developed invention provides a humidity sensing material is disclosed comprising a nanostructured spinel ferrite having the general formula Cu_{0.5}Zn_{0.5}DyₓFe₂₋ₓO₄, where 0<x≤0.02. This material exhibits high surface porosity, reduced crystallite size, and an enhanced electrical response to variations in ambient relative humidity, making it suitable for high-sensitivity humidity detection applications. The nanostructuring and Dy³⁺ doping collectively contribute to its superior sensing capabilities. The crystallite size of the material ranges from approximately 25 nm to 30 nm and shows a consistent reduction with increasing Dy³⁺ substitution. The incorporation of Dy³⁺ ions into the spinel lattice also leads to notable structural changes, including a shift in the X-ray diffraction (XRD) peak positions and lattice expansion when compared to undoped Cu—Zn ferrites, indicating successful substitution and modification of the crystal structure.

In terms of sensing behavior, the material displays a pronounced decrease in electrical resistance with increasing ambient humidity. This change is characterized by a nearly linear response within a wide relative humidity (RH) range of 11% to 97%, enabling accurate and continuous monitoring. Among all compositions, the sample with x=0.02 delivers optimum performance, exhibiting a humidity sensing response of at least 96%, a response time of 10 seconds or less, and a recovery time of 12 seconds or less. The synthesis of the above humidity sensing material is carried out through a solution combustion method. The process begins with the dissolution of stoichiometric amounts of copper nitrate (Cu(NO₃)₂·3H₂O), zinc nitrate (Zn(NO₃)₂·6H₂O), iron nitrate (Fe(NO₃)₃·9H₂O), and dysprosium nitrate (Dy(NO₃)₃·6H₂O) in distilled water. A 1:1 mixture of urea and glucose is added as a fuel to facilitate combustion. The homogeneous solution is then transferred to a furnace maintained at approximately 450° C., where a rapid combustion reaction occurs, leading to the formation of a porous ferrite powder. This synthesis is typically completed within 20 minutes and results in a single-phase spinel structure. A humidity sensing device incorporating the above-described material comprises a sensing element made from the Dy-doped Cu—Zn ferrite, at least two electrodes in electrical contact with the sensing element, and a detection circuit configured to monitor changes in electrical resistance as a function of ambient humidity. The device demonstrates excellent reversibility in its electrical behavior with minimal hysteresis across multiple humidity adsorption and desorption cycles. Furthermore, the sensing material maintains at least 90% of its initial sensitivity after 60 days of continuous exposure to humid environments, attesting to its long-term stability and durability.

FIG. 13 illustrates a Table depicting Structural Parameter obtained by XRD data. FIG. 14 illustrates a Table depicting Magnetization Parameters of Cu_{0.5}Zn_{0.5}DyₓFe₍₂₋ₓ₎O₄ (where x=0, 0.005, 0.01, 0.015, and 0.02).

The present invention relates to a nanostructured humidity sensing material comprising Dysprosium-doped copper-zinc ferrite of the general formula Cu_{0.5}Zn_{0.5}DyₓFe₂₋ₓO₄, where x ranges from 0 to 0.02, synthesized using a solution combustion method. The invention provides a cost-effective, stable, and highly sensitive material for use in humidity sensor devices, characterized by fast response and recovery times, high durability, and minimal hysteresis. The synthesis involves the use of metal nitrates as oxidizers and a 1:1 mixture of urea and glucose as fuel, enabling rapid combustion and formation of single-phase spinel ferrite nanostructures. Structural analysis confirms that the Dy-doped samples retain a cubic spinel structure with lattice expansion and reduced crystallite size upon increasing Dy content. Morphological studies reveal porous, agglomerated particles that facilitate water adsorption. The incorporation of Dy³⁺ ions enhances the hydrophilic nature and electronic properties of the ferrite, resulting in improved humidity sensing performance. The optimal composition (x=0.02) exhibits a high sensing response of ˜96.99%, a response time of ˜10 seconds, and a recovery time of ˜12 seconds. Furthermore, the sensor demonstrates excellent long-term stability over a period of 60 days and low hysteresis, making it suitable for continuous and reversible humidity monitoring.

This invention also includes a humidity sensor device comprising the Dy-doped Cu—Zn ferrite material deposited on a substrate with integrated electrodes. The device operates by detecting changes in electrical resistance across the material in response to varying humidity levels. The performance improvements achieved through rare-earth doping make the material highly promising for environmental monitoring, industrial process control, and smart sensor applications.

We claim:

1. A method for synthesizing dysprosium-doped copper-zinc ferrite nanomaterials, comprising:
dissolving 10-15 wt. % of copper nitrate trihydrate (Cu(NO₃)₂·3H₂O), 10-15 wt. % of zinc nitrate hexahydrate (Zn(NO₃)₂·6H₂O), 59-38 wt. % of iron nitrate nonahydrate (Fe(NO₃)₃·9H₂O), and 1-2 wt. % of dysprosium nitrate hexahydrate (Dy(NO₃)₃·6H₂O) in 20-30 wt. % of distilled water to form an oxidizer solution;
preparing a fuel mixture comprising 40-60 wt. % of urea (NH₂CONH₂) and 60-40 wt. % of glucose (C₆H₁₂O₆) in a 50:50 ratio;
mixing 40-60 wt. % of oxidizer solution with 60-40 wt. % of fuel mixture, preferably in 1:1 ratio, considering their oxidizing and reducing valencies, to form a homogeneous solution;
stirring the homogeneous solution for approximately one hour;
transferring the stirred solution into a Pyrex dish and placing the Pyrex dish containing the solution into a preheated muffle furnace at approximately 450° C.;
allowing the solution to undergo a vigorous combustion reaction, characterized by initial boiling followed by ignition, to produce a fine, porous Cu_{0.5}Zn_{0.5}DyₓFe₂₋ₓO₄ ferrite powder within approximately 20 minutes; and
grinding the obtained ferrite powder into fine particles to ensure homogeneity, wherein the dissolving of copper nitrate trihydrate, zinc nitrate hexahydrate, iron nitrate nonahydrate, and dysprosium nitrate hexahydrate in distilled water is conducted by sequential addition in the order of copper nitrate, zinc nitrate, iron nitrate, and dysprosium nitrate, with continuous stirring using a magnetic stirrer set at 450±50 rpm, the temperature of the solution being maintained within 35-45° C. to avoid hydrolysis of nitrates, the pH being monitored and adjusted between 5.5 and 6.5 using dilute nitric acid to suppress premature hydroxide formation, and the dissolution being continued for a minimum of 25 minutes for each salt until complete transparency of the solution is achieved, resulting in a clear oxidizer solution with homogeneously distributed metal ions; and wherein the preparation of the fuel mixture comprising urea and glucose in equal proportions is carried out by pre-drying the glucose at 90-100° C. for 2 hours to remove adsorbed moisture, followed by blending with urea in a mortar and pestle until a uniform powder blend is obtained, and wherein the blend is further dissolved in 15-20 wt. % distilled water under stirring at 300-400 rpm to form a viscous, transparent fuel solution, the viscosity being controlled within 1.5-2.0 mPa·s to facilitate optimal redox interaction with the oxidizer solution in subsequent mixing; and
wherein the mixing of the oxidizer solution and the fuel mixture in a 1:1 ratio based on oxidizing and reducing valencies is performed dropwise by adding the fuel solution into the oxidizer solution over a period of 20-30 minutes under vigorous stirring at 500-600 rpm, with the temperature maintained at 60-70° C. to promote partial solvent evaporation, the viscosity of the resultant precursor solution being continuously monitored until it reaches 2.5-3.0 mPa·s, which ensures uniform distribution of cations and fuel molecules within the gel-like matrix; and wherein the homogeneous solution is subjected to constant stirring for one hour under reflux conditions using a water-jacketed condenser, with the solution temperature maintained at 70-80° C., the purpose being to suppress uncontrolled vapor loss of nitric acid vapors, the stirring being carried out at 550±25 rpm until the solution exhibits a uniform pale-yellow color indicating homogenous chelation of all metal nitrates with the fuel matrix, with the refractive index measured periodically to confirm stability of the precursor solution.

2. The method of claim 1, wherein the combustion duration is between 15 to 25 minutes, resulting in rapid synthesis and energy efficiency; and wherein the amounts are calculated based on oxidizer solution to fuel mixture ratio (O/F) to 1 of Cu_{0.5}Zn_{0.5}DyₓFe₂₋ₓO₄, where x is selected from the group consisting of 0, 0.005, 0.01, 0.015, and 0.02.

3. The method of claim 1, further comprising detecting ambient humidity using a sensor comprising Cu_{0.5}Zn_{0.5}DyₓFe₂₋ₓO₄ nanomaterial, comprising:
exposing the sensor material to ambient air;
detecting a change in electrical property (resistance or capacitance) of the sensor due to humidity-induced proton conduction or adsorption mechanisms;
processing the change in signal to determine the relative humidity of the environment; and
displaying or transmitting the humidity level for monitoring or control applications.

4. The method of claim 3, wherein the sample with x=0.02 exhibits:
a humidity sensing response of at least 96%,
a response time of ≤10 seconds, and
a recovery time of ≤12 seconds; and wherein the sensing material maintains ≥90% of its initial sensitivity after continuous operation for at least 60 days under humidity exposure, wherein the sensing element demonstrates reversible electrical behavior with minimal hysteresis during repeated adsorption and desorption cycles.

5. The method of claim 1, wherein the weight ratio of oxidizer solution to fuel mixture is 1:1; wherein the weight percentage of copper nitrate trihydrate (Cu(NO₃)₂·3H₂O), zinc nitrate hexahydrate (Zn(NO₃)₂·6H₂O), iron nitrate nonahydrate (Fe(NO₃)₃·9H₂O), dysprosium nitrate hexahydrate (Dy(NO₃)₃·6H₂O), and distilled water is 13.11%, 13.49%, 45.64%, 1.34%, and 26.41%, respectively; and wherein the weight percentage of urea (NH₂CONH₂), and glucose (C₆H₁₂O₆), is 50%, and 50%, respectively.

6. The method of claim 1, wherein the Pyrex dish containing the precursor solution is preheated at 100-120° C. in a hot air oven for 10-15 minutes before insertion into the muffle furnace, the preheating step being used to evaporate surface water and increase viscosity of the solution, the dish being filled only up to 60-70% of its volume to accommodate the subsequent foaming and expansion during combustion, and the muffle furnace chamber being pre-stabilized for 15 minutes at 450° C. prior to insertion to ensure a uniform ignition environment; and wherein the vigorous combustion reaction initiated in the muffle furnace is characterized by three distinct stages comprising an initial boiling phase producing dense brown NOx fumes, a self-ignition stage producing a yellowish flame sustained for 20-40 seconds, and a final ash formation stage yielding a fluffy, porous black ferrite powder, with the total reaction time being controlled within 15-25 minutes by regulating airflow in the furnace chamber between 50-70 sccm, the airflow being essential for removal of residual gaseous byproducts and avoidance of localized carbon deposits.

7. The method of claim 1, wherein the obtained ferrite powder is subjected to grinding using an agate mortar for 15-20 minutes followed by mechanical milling in a planetary ball mill operated at 250-300 rpm for 5-6 hours using zirconia balls of 8-10 mm diameter, the ball-to-powder weight ratio being maintained at 10:1, the milling process being intermittently paused every 30 minutes to prevent excessive heating of the sample, the final particle size distribution being measured using dynamic light scattering to confirm crystallite size within 30-45 nm, and wherein the ground powder is calcined in an alumina crucible at 650-750° C. for 2-3 hours in static air, the heating rate being controlled at 3-5° C. per minute to avoid rapid decomposition, the cooling being conducted naturally inside the closed furnace chamber to maintain oxygen stoichiometry of the ferrite lattice, and the crystallinity being confirmed by X-ray diffraction showing well-defined peaks corresponding to spinel ferrite structure with lattice parameter variations attributed to dysprosium substitution.

8. The method of claim 1, wherein the combustion precursor solution is doped with a chelating agent selected from citric acid or ethylenediaminetetraacetic acid (EDTA) in an amount of 1-3 wt. % relative to total solution weight, the chelating agent being added prior to stirring, the chelating functionality being intended to stabilize cationic distribution and prevent local agglomeration; and wherein the synthesized Cu_{0.5}Zn_{0.5}DyₓFe₂₋ₓO₄ ferrite nanomaterial is pressed into pellets of 10-12 mm diameter and 2-3 mm thickness using a uniaxial hydraulic press at 4-5 tons pressure, the pellets being sintered at 800-850° C. for 4-6 hours under air atmosphere, the sintering profile being controlled at a heating rate of 2° C. per minute and cooling rate of 1° C. per minute to avoid cracking, and the resultant sintered bodies being used as sensing elements in humidity sensing devices.

9. The method of claim 3, wherein the humidity sensor employing Cu_{0.5}Zn_{0.5}DyₓFe₂₋ₓO₄ material is fabricated by screen-printing the ferrite paste onto an alumina substrate with pre-patterned interdigitated silver electrodes, the paste being prepared by dispersing ferrite powder in ethanol and polyvinyl alcohol binder, the printed layer being dried at 100° C. for 2 hours and annealed at 300° C. for 1 hour to remove the binder, the sensing element being encapsulated in a perforated polymer housing to permit free passage of water vapor while protecting the element from dust and mechanical damage; and wherein the electrical response of the sensor is measured by applying an AC voltage of 1-5 V at a frequency of 1-10 kHz across the electrodes, the resistance variation being recorded using an LCR meter under controlled humidity conditions varied from 10% to 90% relative humidity in a climatic chamber, the sensitivity being defined as the ratio of resistance at 90% RH to resistance at 10% RH, and the data being transmitted via a Bluetooth low-energy module integrated with the sensing platform.

10. The method of claim 1, wherein the response and recovery times of the humidity sensor are measured by subjecting the sensing element alternately to 10% and 90% relative humidity in a programmable humidity chamber, the switching interval being 30 seconds, the response being recorded as the time taken for 90% change in resistance value upon humidity increase, and the recovery being defined as the time taken for 90% return to baseline resistance upon humidity decrease, the measurements being repeated for 1000 cycles to validate stability; and wherein the long-term stability of the sensor is evaluated by continuous exposure at 60% relative humidity and 30° C. for a period of 60 days, the resistance being recorded daily, the sensitivity degradation being calculated as the percentage reduction in response compared to initial sensitivity, and the sensor being considered operationally stable when the degradation does not exceed 10% over the test period; and wherein the hysteresis of the sensor is measured by recording resistance values during increasing humidity from 10% to 90% and during decreasing humidity from 90% to 10%, the hysteresis error being calculated as the maximum difference between the two resistance curves expressed as a percentage of full-scale deflection, and the hysteresis being controlled below 5% by optimizing sintering temperature of the ferrite pellet.

11. The method of claim 1, wherein the particle morphology of the synthesized ferrite powder is tuned by controlling the fuel-to-oxidizer ratio within the range of 0.9:1 to 1.1:1, the near-stoichiometric balance promoting self-sustained combustion, off-stoichiometric ratios producing either oxygen-deficient or carbon-rich phases, and the morphology being analyzed by transmission electron microscopy to confirm spherical nanocrystals with uniform size distribution; and wherein the furnace atmosphere during combustion is modified by introducing a controlled flow of oxygen-nitrogen mixture containing 80-90% oxygen at 50 sccm, the oxygen enrichment being maintained throughout the 15-25 minute combustion period, the enriched atmosphere promoting complete oxidation of fuel species, reducing residual carbon, and improving phase purity of the final ferrite material.

12. The method of claim 1, wherein the precursor solution is ultrasonicated at 40 kHz frequency and 150 W power for 20-25 minutes prior to combustion, the sonication promoting nanoscale dispersion of nitrate salts and fuel molecules, the cavitation effects breaking weak agglomerates; and wherein the grinding step includes wet-milling the combustion powder in ethanol medium using zirconia beads of 2 mm diameter for 3 hours at 250 rpm, the ethanol acting as a process control agent to prevent excessive cold welding of particles, the slurry being subsequently dried at 80° C. for 12 hours in a vacuum oven.

13. The method of claim 1, wherein the calcined powder is subjected to controlled annealing under a reducing atmosphere consisting of 95% nitrogen and 5% hydrogen at 500-600° C. for 1-2 hours, the reduction treatment being used to tune the oxygen vacancy concentration in the ferrite lattice, the vacancies acting as active sites for water vapor adsorption during humidity sensing, and the modified material showing enhanced response characteristics compared to samples annealed in air.

14. The method of claim 1, wherein the dysprosium content is selectively tuned within the values of x=0, 0.005, 0.01, 0.015, and 0.02, the structural modifications being analyzed by Rietveld refinement of X-ray diffraction data to determine lattice parameter contraction with increasing dysprosium substitution, the magnetic response being studied by vibrating sample magnetometry, and the optimal composition x=0.02 being identified for humidity sensing due to the highest density of surface defect states enabling fast adsorption-desorption kinetics.

15. The method of claim 1, wherein the precursor solution after stirring is concentrated by rotary evaporation under reduced pressure at 60-65° C. for 20-30 minutes, the vacuum level being maintained at 200-250 mbar, the evaporation reducing the solvent volume by 30-40%, the semi-viscous concentrate being transferred directly into the Pyrex dish, and the concentration step enabling more uniform ignition during combustion and preventing splattering of solution inside the furnace chamber.

16. The method of claim 1, wherein the Pyrex dish containing the precursor solution is placed inside the muffle furnace within a secondary ceramic tray filled with fine alumina powder, the alumina powder acting as a thermal buffer to distribute heat evenly across the bottom of the Pyrex dish, the buffering arrangement reducing localized overheating at the base of the dish and preventing incomplete combustion or adherence of partially reacted material to the vessel surface.

17. The method of claim 1, wherein the combustion is initiated under a pulsed heating schedule consisting of alternating 5-7 minute high-heat intervals at 450-460° C. and 3-4 minute hold intervals at 200-250° C., the pulsed schedule being achieved by electronically cycling the furnace heating element, the thermal cycling promoting controlled expansion and foaming of the precursor mass and reducing violent eruptions that typically occur under continuous heating.

18. The method of claim 1, wherein during the combustion stage, the furnace lid is partially opened to a gap of 2-3 cm for the first 5 minutes of reaction to allow controlled escape of evolving gases, followed by full closure of the furnace chamber once visible ignition has stabilized, the partial venting preventing excessive internal pressure build-up and reducing uncontrolled ejection of precursor material during the ignition stage; and wherein after completion of combustion, the hot porous ferrite powder is subjected to an in-situ quenching step by rapidly transferring the Pyrex dish from the furnace chamber to a closed desiccator maintained at 30-40% relative humidity and 25-30° C. ambient temperature, the sudden cooling suppressing grain coarsening and locking in the nanoscale pore architecture formed during combustion.
